(19) United States
(12) Patent Application Publication
(10) Pub. No.: US 2026/0067591 A1
(43) Pub. Date: Mar. 5, 2026

(54) GREEN GHOST DETECTION

(71) Applicant: APPLE INC., Cupertino, CA (US)

(72) Inventors: Muge Wang, San Jose, CA (US); Maxim SMIRNOV, Wilsonville, OR (US); Husam KHASHIBOUN, San Jose, CA (US); Assaf METUKI, Herut (IL); Danny GAL, Hod HaSharon (IL)

(73) Assignee: APPLE INC., Cupertino, CA (US)

(21) Appl. No.: 18/825,924

(22) Filed: Sep. 5, 2024

(51) Int. Cl. H04N 25/626; G06T 7/00; G06T 7/90

(52) U.S. Cl. CPC H04N 25/626; G06T 7/0002; G06T 7/90; G06T 2207/10024; G06T 2207/30168

(57) ABSTRACT

Disclosed herein are a system, method, and computer program product embodiments for detecting green ghost artifacts utilizing different classification techniques. One technique utilizes a keypoint generation-based classifier, where keypoint(s) corresponding to green ghost artifact(s) are generated in a region of an image that likely includes such artifacts. Another technique utilizes a mask image generation-based classifier, where a mask image is generated that includes confidence level(s) for pixel(s) that indicate a likelihood that such pixel(s) include such artifacts. A further technique utilizes a temporal filtering-based classifier, where a patch distance between a patch of pixels of the image and a patch of pixels of a corresponding history image is determined. The patch distance indicates a likelihood that such artifacts are present in the image. The output of such classifiers are utilized collectively to determine whether such artifacts are present in the image.

### BACKGROUND

Cameras in integrated computing devices, such as smartphones and tablets, can face various constraints, e.g., processing power constraints, thermal constraints, and physical size constraints. Such constraints can cause manufacturers to make tradeoffs between using cameras with optimal image capture capabilities and those that will meet the constraints of the computing devices into which they are being integrated. For example, unwanted artifacts may often appear in digital images captured by such integrated camera devices, e.g., due to the optics of the lenses used, sensor characteristics, and/or the aforementioned constraints faced by integrated image capture devices.

One type of artifact is an unwanted reflection artifact. These unwanted reflection artifacts can present themselves as brightly-colored spots, circles, rings, or halos that reflect the shape of a bright light source in the captured image. These artifacts, also referred to herein as “ghosts” or “green ghosts” (due to often having a greenish tint), can be located in regions of the captured images where there is not actually a bright light source located in the image. Such artifacts can be caused by light scattering and reflection within the optical elements and image sensor of a camera system. The green color of the artifact can be caused by spectral properties of the image sensor.

### SUMMARY

Various embodiments for detecting green ghost artifacts are disclosed. In some embodiments, a method includes identifying a region of an image related to a light source in the image, where the image is captured by an image sensor. The method also includes determining a keypoint in the region of the image based on a size of the light source. The method further includes generating a probable artifact indicator that indicates a likelihood that the keypoint corresponds to an artifact in the image based on a brightness level of the determined keypoint and providing the probable artifact indicator to an artifact mitigation engine.

In some embodiments, a system includes system memory and at least one processor. The at least one processor is configured to identify a region of an image related to a light source in the image, where the image is captured by an image sensor. The at least one processor is also configured to determine a keypoint in the region of the image based on a size of the light source. The at least one processor is further configured to generate a probable artifact indicator that indicates a likelihood that the keypoint corresponds to an artifact in the image based on a brightness level of the determined keypoint and provide the probable artifact indicator to an artifact mitigation engine.

In some embodiments, a non-transitory computer readable medium having instructions stored thereon that, when executed by at least one processor, cause the at least one processor to perform operations. The operations include identifying a region of an image related to a light source in the image, where the image is captured by an image sensor. The operations also include determining a keypoint in the region of the image based on a size of the light source. The operations further include generating a probable artifact indicator that indicates a likelihood that the keypoint corresponds to an artifact in the image based on a brightness level of the determined keypoint and providing the probable artifact indicator to an artifact mitigation engine.

### BRIEF DESCRIPTION OF THE DRAWINGS

The accompanying drawings are incorporated herein and form a part of the specification.

FIG. 1 is a diagram of an electronic device, according to some embodiments.

FIG. 2 is a block diagram illustrating components in an electronic device, according to some embodiments.

FIG. 3 is a block diagram illustrating image processing pipelines implemented using an image signal processor, according to some embodiments.

FIG. 4 is an example image including an artifact.

FIG. 5 is a block diagram of a system for detecting green ghost artifacts, according to some embodiments.

FIG. 6 is a block diagram of a keypoint generation-based classifier, according to some embodiments.

FIG. 7 is an example of an image with a first region corresponding to a bright light source and a corresponding second region in which a green ghost artifact is identified.

FIG. 8 is a block diagram of a mask image generation-based classifier, according to some embodiments.

FIG. 9 is a graph illustrating different luma confidence values, according to some embodiments.

FIG. 10 is a graph illustrating different hue, saturation, or brightness-based confidence values, according to some embodiments.

FIG. 11 is a graph illustrating different chrominance confidence values, according to some embodiments.

FIG. 12 is a graph illustrating different luma confidence values, according to some embodiments.

FIG. 13 is a block diagram of a temporal filtering-based classifier, according to some embodiments.

FIG. 14 is a flowchart of a method for identifying a green ghost artifact utilizing a keypoint generation-based classifier, according to some embodiments.

FIG. 15 is a flowchart of a method for providing a probable artifact indicator, according to some embodiments.

FIG. 16 is a flowchart of a method for identifying a green ghost artifact utilizing a mask image generation-based classifier, according to some embodiments.

FIG. 17 is a flowchart of a method for providing a confidence level to an artifact mitigation engine, according to some embodiments.

FIG. 18 is a flowchart of a method for determining a confidence level utilizing a mask image generation-based classifier based on a first image processing mode, according to some embodiments.

FIG. 19 is a flowchart of a method for determining a confidence level utilizing a mask image generation-based classifier based on a second image processing mode, according to some embodiments.

FIG. 20 is a flowchart of a method for determining a patch distance utilizing temporal filtering-based classifier based, according to some embodiments.

FIG. 21 is an example computer system that can be used for implementing some aspects or portion(s) thereof.

In the drawings, like reference numbers generally indicate identical or similar elements. Additionally, generally, the left-most digit(s) of a reference number identifies the drawing in which the reference number first appears.

### DETAILED DESCRIPTION

Due to various optical elements in a camera, various bright light sources (e.g., the Sun) can cause green ghost artifacts in captured images, which can deteriorate image quality and/or obscure other elements in a captured scene. Based on the embodiments described herein, one or more classification techniques may be utilized to detect green ghost artifacts. One classification technique may utilize a keypoint generation-based classifier in which keypoint(s) corresponding to green ghost artifact(s) are generated in a region of an image determined to likely include green ghost artifact(s). Another classification technique may utilize a mask image generation-based classifier in which a mask image is generated that includes confidence level(s) based on a color mask for pixel(s) of the image that indicate a likelihood that such pixel(s) include green ghost artifact(s). A further classification technique may utilize a temporal filtering-based classifier in which a patch distance between a patch of pixels of the image and a patch of pixels of a corresponding history image is determined. The patch distance may indicate a likelihood that the green ghost artifact is present at a location of the image corresponding to the patch(es) of pixels. The output of such classifiers may be utilized collectively to determine whether in fact green ghost artifact(s) are present in the image. An artifact mitigation engine may mitigate detected green ghost artifact(s), thereby improving the image quality of the image.

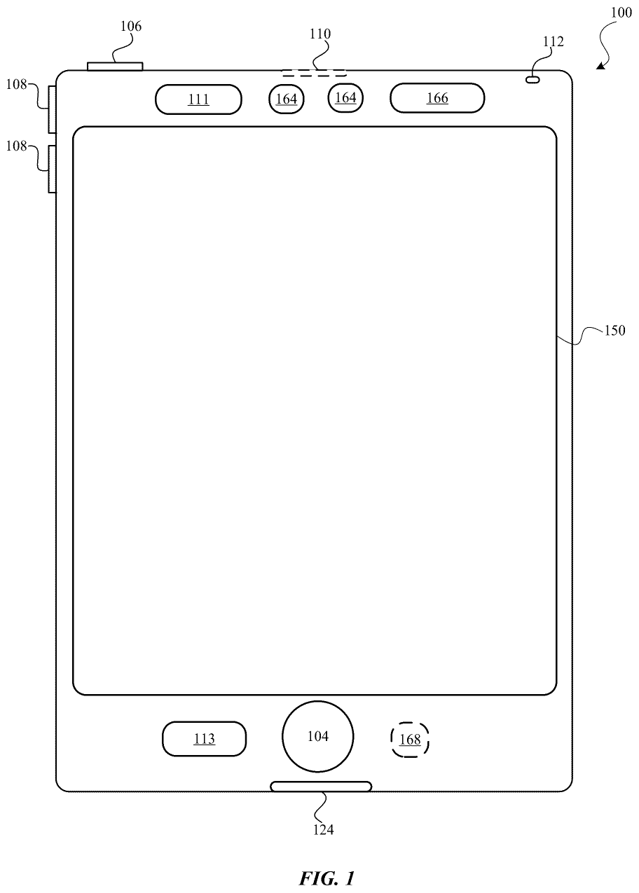

Embodiments of electronic devices, user interfaces for such devices, and associated processes for using such devices are described. In some embodiments, the device is a portable communications device, such as a mobile telephone, that also includes other functions, such as personal digital assistant (PDA) and/or music player functions. Exemplary embodiments of portable multifunction devices include, without limitation, the iPhone®, iPod Touch®, Apple Watch®, and iPad® devices from Apple Inc. of Cupertino, California. Other portable electronic devices, such as wearables, laptops or tablet computers, are optionally used. In some embodiments, the device is not a portable communication device, but is a desktop computer or other computing device that is not designed for portable use. In some embodiments, the disclosed electronic device may include a touch-sensitive surface (e.g., a touch screen display and/or a touchpad). An example electronic device described below in conjunction with FIG. 1 (e.g., device 100) may include a touch-sensitive surface for receiving user input. The electronic device may also include one or more other physical user-interface devices, such as a physical keyboard, a mouse and/or a joystick.

FIG. 1 is a diagram of an electronic device 100, according to one embodiment. Device 100 may include one or more physical buttons, such as a “home” or menu button 104. Menu button 104 is, for example, used to navigate to any application in a set of applications that are executed on device 100. In some embodiments, menu button 104 includes a fingerprint sensor that identifies a fingerprint on menu button 104. The fingerprint sensor may be used to determine whether a finger on menu button 104 has a fingerprint that matches a fingerprint stored for unlocking device 100. Alternatively, in some embodiments, menu button 104 is implemented as a soft key in a graphical user interface (GUI) displayed on a touch screen.

In some embodiments, device 100 includes touch screen 150, menu button 104, push button 106 for powering the device on/off and locking the device, volume adjustment buttons 108, Subscriber Identity Module (SIM) card slot 110, head set jack 112, and docking/charging external port 124. Push button 106 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 includes various components including a memory (which may include one or more computer readable storage mediums), a memory controller, one or more central processing units (CPUs), a peripherals interface, an RF circuitry, an audio circuitry, speaker 111, microphone 113, input/output (I/O) subsystem, and other input or control devices. Device 100 may include one or more image sensors 164, one or more proximity sensors 166, and one or more accelerometers 168. Device 100 may include more than one type of image sensor 164. Each type may include more than one image sensor 164. For example, one type of image sensor 164 may be a camera and another type of image sensor 164 may be infrared sensor that may be used for face recognition. Additionally or alternatively, image sensors 164 may be associated with different lens configuration. For example, device 100 may include rear image sensors, one with a wide-angle lens and another with as a telephoto lens. Device 100 may include components not shown in FIG. 1, such as an ambient light sensor, a dot projector and a flood illuminator.

Device 100 is only one example of an electronic device, and device 100 may have more or fewer components than listed above, some of which may be combined into a component or have a different configuration or arrangement. The various components of device 100 listed above are embodied in hardware, software, firmware, or a combination thereof, including one or more signal processing and/or application specific integrated circuits (ASICs). While the components in FIG. 1 are shown as generally located on the same side as the touch screen 150, one or more components may also be located on an opposite side of device 100. For example, the front side of device 100 may include an infrared image sensor 164 for face recognition and another image sensor 164 as the front camera of device 100. The back side of device 100 may also include additional image sensors 164 as the rear cameras of device 100.

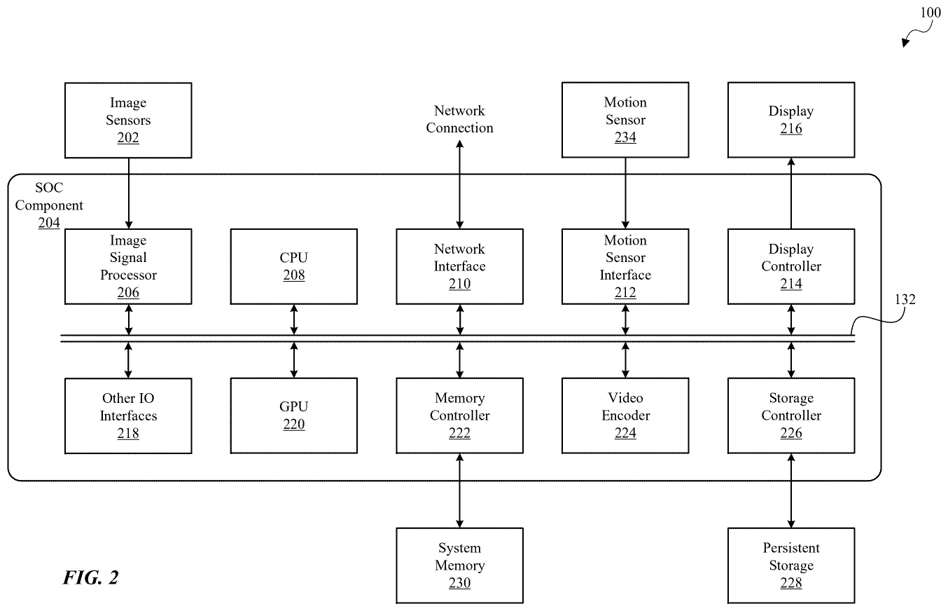

FIG. 2 is a block diagram illustrating components in device 100, according to one embodiment. Device 100 may perform various operations including image processing. For this and other purposes, device 100 may include image sensors 202, a system-on-a chip (SOC) component 204, a system memory 230, a persistent storage (e.g., flash memory) 228, an orientation sensor 234, and a display 216. The components as illustrated in FIG. 2 are merely illustrative. For example, device 100 may include other components (e.g., speaker or microphone) that are not illustrated in FIG. 2. Further, some components (e.g., orientation sensor 234) may be omitted from device 100.

Image sensors 202 are components for capturing image data. Each of image sensors 202 may be embodied, for example, as a complementary metal-oxide-semiconductor (CMOS) active-pixel sensor, a camera, video camera, or other devices. Image sensors 202 generate raw image data that is sent to SOC component 204 for further processing. In some embodiments, the image data processed by SOC component 204 is displayed on display 216, stored in system memory 230 and/or persistent storage 228, or sent to a remote computing device via a network connection. The raw image data generated by image sensors 202 may be in a Bayer color filter array (CFA) pattern (hereinafter also referred to as “Bayer pattern”) or a Quad Bayer pattern (hereinafter also referred to as a “Quadra pattern.”) Image sensor 202 may also include optical and mechanical components that assist image sensing components (e.g., pixels) to capture images. The optical and mechanical components may include an aperture, a lens system, and an actuator that controls the focal length of image sensor 202.

Motion sensor 234 is a component or a set of components for sensing motion of device 100. Motion sensor 234 may generate sensor signals indicative of orientation and/or acceleration of device 100. The sensor signals are sent to SOC component 204 for various operations, such as turning on device 100 or rotating images displayed on display 216.

Display 216 is a component for displaying images as generated by SOC component 204. Display 216 may include, for example, a liquid crystal display (LCD) device or an organic light emitting diode (OLED) device. Based on data received from SOC component 204, display 116 may display various images, such as menus, selected operating parameters, images captured by image sensors 202 and processed by SOC component 204, and/or other information received from a user interface of device 100 (not shown).

System memory 230 is a component for storing instructions for execution by SOC component 204 and for storing data processed by SOC component 204. System memory 230 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM), or a combination thereof. In some embodiments, system memory 230 may store pixel data or other image data or statistics in various formats.

Persistent storage 228 is a component for storing data in a non-volatile manner. Persistent storage 228 retains data even when power is not available. Persistent storage 228 may be embodied as read-only memory (ROM), flash memory, or other non-volatile random access memory devices.

SOC component 204 is embodied as one or more integrated circuit (IC) chips and performs various data processing processes. SOC component 204 may include image signal processor (ISP) 206, a central processor unit (CPU) 208, a network interface 210, a motion sensor interface 212, a display controller 214, a graphics processor (GPU) 220, a memory controller 222, a video encoder 224, a storage controller 226, and various other input/output (I/O) interfaces 218, and bus 232 connecting these subcomponents. SOC component 204 may include more or fewer subcomponents than those shown in FIG. 2.

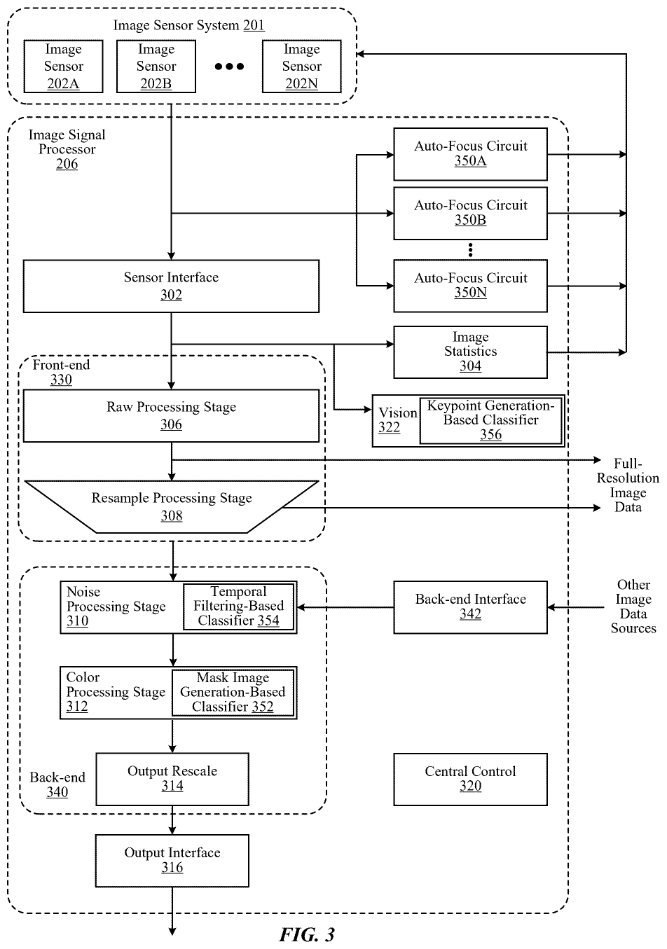

ISP 206 is hardware that performs various stages of an image processing pipeline. In some embodiments, ISP 206 may receive raw image data from image sensors 202 and process the raw image data into a form that is usable by other subcomponents of SOC component 204 or components of device 100. ISP 206 may perform various image-manipulation operations, such as image translation operations, horizontal and vertical scaling, color space conversion and/or image stabilization transformations, as described below in detail with reference to FIG. 3.

CPU 208 may be embodied using any suitable instruction set architecture and may be configured to execute instructions defined in that instruction set architecture. CPU 208 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 2, SOC component 204 may include multiple CPUs. In multiprocessor systems, each of the CPUs may commonly, but not necessarily, implement the same ISA.

Graphics processing unit (GPU) 220 is graphics processing circuitry for performing operations on graphical data. For example, GPU 220 may render objects to be displayed into a frame buffer (e.g., one that includes pixel data for an entire frame). GPU 220 may include one or more graphics processors that may execute graphics software to perform a part or all of the graphics operation, or hardware acceleration of certain graphics operations.

I/O interfaces 218 are hardware, software, firmware or combinations thereof for interfacing with various input/output components in device 100. I/O components may include devices, such as keypads, buttons, audio devices, and sensors (e.g., a global positioning system). I/O interfaces 218 process data for sending data to such I/O components or process data received from such I/O components.

Network interface 210 is a subcomponent that enables data to be exchanged among devices 100 and other devices via one or more networks (e.g., carrier or agent devices). For example, video or other image data may be received from other devices via network interface 210 and be stored in system memory 230 for subsequent processing (e.g., via a back-end interface to image signal processor 206, such as discussed below in FIG. 3) and display. The networks may include, Local Area Networks (LANs) (e.g., an Ethernet or corporate network) and Wide Area Networks (WANs). The image data received via network interface 210 may undergo image processing processes by ISP 206.

Motion sensor interface 212 is circuitry for interfacing with motion sensor 234. Motion sensor interface 212 receives sensor information from motion sensor 234 and processes the sensor information to determine the orientation or movement of device 100.

Display controller 214 is circuitry for sending image data to be displayed on display 216. Display controller 214 receives the image data from ISP 206, CPU 208, graphic processor or system memory 230 and processes the image data into a format suitable for display on display 216.

Memory controller 222 is circuitry for communicating with system memory 230. Memory controller 222 may read data from system memory 230 for processing by ISP 206, CPU 208, GPU 220, or other subcomponents of SOC component 204. Memory controller 222 may also write data to system memory 230 received from various subcomponents of SOC component 204.

Video encoder 224 is hardware, software, firmware, or a combination thereof for encoding video data into a format suitable for storing in persistent storage 228 or for passing the data to network interface 210 for transmission over a network to another device.

In some embodiments, one or more subcomponents of SOC component 204 or some functionality of these subcomponents may be performed by software components executed on ISP 206, CPU 208, or GPU 220. Such software components may be stored in system memory 230, persistent storage 228, or another device communicating with device 100 via network interface 210.

Image data or video data may flow through various data paths within SOC component 204. In one example, raw image data may be generated from image sensors 202 and processed by ISP 206 and then sent to system memory 230 via bus 232 and memory controller 222. After the image data is stored in system memory 230, it may be accessed by video encoder 224 for encoding or by display 116 for displaying via bus 232.

In another example, image data is received from sources other than image sensors 202. For example, video data may be streamed, downloaded, or otherwise communicated to SOC component 204 via wired or wireless network. The image data may be received via network interface 210 and written to system memory 230 via memory controller 222. The image data may then be obtained by ISP 206 from system memory 230 and processed through one or more image processing pipeline stages, as described below in detail with reference to FIG. 3. The image data may then be returned to system memory 230 or be sent to video encoder 224, display controller 214 (e.g., for display on display 216), or storage controller 226 for storage at persistent storage 228.

FIG. 3 is a block diagram illustrating image processing pipelines implemented using ISP 206, according to one embodiment. In some embodiments, ISP 206 is coupled to an image sensor system 201 that includes one or more image sensors 202A through 202N (hereinafter collectively referred to as “image sensors 202” or also referred individually as “image sensor 202”) to receive raw image data. Image sensor system 201 may include one or more sub-systems that control image sensors 202 individually. In some embodiments, each image sensor 202 may operate independently while, in other cases, image sensors 202 may share one or more components. For example, two or more image sensors 202 may share the same circuit board that controls the mechanical components of the image sensors (e.g., actuators that change the focal lengths of each image sensor). The image sensing components of image sensor 202 may include different types of image sensing components that may provide raw image data in different forms to ISP 206. For example, the image sensing components may include multiple focus pixels that are used for auto-focusing and multiple image pixels that are used for capturing images. In some embodiments, the image sensing pixels may be used for both auto-focusing and image capturing purposes.

ISP 206 implements an image processing pipeline which may include a set of stages that process image information from creation, capture, or receipt to output. ISP 206 may include a sensor interface 302, a central control 320, front-end pipeline stages 330, back-end pipeline stages 340, an image statistics module 304, a vision module 322, a back-end interface 342, an output interface 316, and auto-focus circuits 350A through 350N (hereinafter collectively referred to as “auto-focus circuits 350” or referred individually as “auto-focus circuits 350”). ISP 206 may include other components not illustrated in FIG. 3 or may omit one or more components illustrated in FIG. 3.

In some embodiments, different components of ISP 206 process image data at different rates. In some embodiments, front-end pipeline stages 330 (e.g., raw processing stage 306 and resample processing stage 308) may process image data at an initial data rate. Thus, the various different techniques, adjustments, modifications, or other processing operations may be performed by these front-end pipeline stages 330 at the initial data rate. For example, if front-end pipeline stages 330 process two pixels per clock cycle, then raw processing stage 306 operations (e.g., black level compensation, highlight recovery, and defective pixel correction) may process two pixels of image data at a time. In contrast, one or more back-end pipeline stages 340 may process image data at a different data rate less than the initial data rate. For example, in some embodiments, back-end pipeline stages 340 (e.g., noise processing stage 310, color processing stage 312, and output rescale 314) may be processed at a reduced data rate (e.g., one pixel per clock cycle).

Raw image data captured by image sensors 202 may be transmitted to different components of ISP 206 in different manners. In some embodiments, raw image data corresponding to the focus pixels may be sent to auto-focus circuits 350 while raw image data corresponding to the image pixels may be sent to sensor interface 302. In some embodiments, raw image data corresponding to both types of pixels may simultaneously be sent to both auto-focus circuits 350 and sensor interface 302.

Auto-focus circuits 350 may include a hardware circuit that analyzes raw image data to determine an appropriate focal length of each image sensor 202. In some embodiments, the raw image data may include data that is transmitted from image sensing pixels that perform image focusing operations. In some embodiments, raw image data from image capture pixels may also be used for auto-focusing purpose. Auto-focus circuit 350 may perform various image processing operations to generate data that determines the appropriate focal length. The image processing operations may include cropping, binning, image compensation, and scaling to generate data that is used for auto-focusing purpose, etc. The auto-focusing data generated by auto-focus circuits 350 may be fed back to image sensor system 201 to control the focal lengths of image sensors 202. For example, image sensor 202 may include a control circuit that analyzes the auto-focusing data to determine a command signal that is sent to an actuator associated with the lens system of image sensor 202 to change the focal length of image sensor 202. The data generated by auto-focus circuits 350 may also be sent to other components of ISP 206 for other image processing purposes. For example, some of the data may be sent to image statistics module 304 to determine information regarding auto-exposure.

Auto-focus circuits 350 may be individual circuits that are separate from other components, such as image statistics module 304, sensor interface 302, front-end 330, and back-end 340. This allows ISP 206 to perform auto-focusing analysis independent of other image processing pipelines. For example, ISP 206 may analyze raw image data from image sensor 202A to adjust the focal length of image sensor 202A using auto-focus circuit 350A while performing downstream image processing of the image data from image sensor 202B simultaneously. In some embodiments, the number of auto-focus circuits 350 may correspond to the number of image sensors 202. In other words, each image sensor 202 may have a corresponding auto-focus circuit that is dedicated to the auto-focusing of image sensor 202. Device 100 may perform auto focusing for different image sensors 202 even if one or more image sensors 202 are not in active use. This allows a seamless transition between two image sensors 202 when device 100 switches from one image sensor 202 to another. For example, device 100 may include a wide-angle camera and a telephoto camera as a dual back camera system for photo and image processing. Device 100 may display images captured by one of the dual cameras and may switch between the two cameras from time to time. The displayed images may seamless transition from image data captured by one image sensor 202 to image data captured by another image sensor 202 without waiting for second image sensor 202 to adjust its focal length because two or more auto-focus circuits 350 may continuously provide auto-focus data to image sensor system 201.

Raw image data captured by different image sensors 202 may also be transmitted to sensor interface 302. Sensor interface 302 receives raw image data from image sensors 202 and processes the raw image data into an image data processable by other stages in the pipeline. Sensor interface 302 may perform various preprocessing operations, such as image cropping, binning or scaling to reduce image data size. In some embodiments, pixels are sent from image sensors 202 to sensor interface 302 in raster order (e.g., horizontally, line by line). The subsequent processes in the pipeline may also be performed in raster order and the result may also be output in raster order. Although only a single image sensor system 201 and a single sensor interface 302 are illustrated in FIG. 3, when more than one image sensor system is provided by device 100, a corresponding number of sensor interfaces may be provided in ISP 206 to process raw image data from each image sensor system.

Front-end pipeline stages 330 process image data in raw or full-color domains. Front-end pipeline stages 330 may include raw processing stage 306 and resample processing stage 308. A raw image data may be in a Bayer raw image format or a Quadra raw image format, for example. In such raw image format, pixel data with values specific to a particular color (instead of all colors) is provided in each pixel. In an image capturing sensor, image data can be provided in the Bayer or Quadra pattern. Raw processing stage 306 may process image data in the Bayer or Quadra raw image format.

The operations performed by raw processing stage 306 include sensor linearization, black level compensation, fixed pattern noise reduction, defective pixel correction, raw noise filtering, lens shading correction, white balance gain, and highlight recovery. Sensor linearization refers to mapping non-linear image data to linear space for other processing. Black level compensation refers to providing digital gain, offset and clip independently for each color component (e.g., Gr, R, B, Gb) of the image data. Fixed pattern noise reduction refers to removing offset fixed pattern noise and gain fixed pattern noise by subtracting a dark frame from an input image and multiplying different gains to pixels. Defective pixel correction refers to detecting defective pixels, and then replacing defective pixel values. Raw noise filtering refers to reducing noise of image data by averaging neighboring pixels that are similar in brightness. Highlight recovery refers to estimating pixel values for those pixels that are clipped (or nearly clipped) from other channels. Lens shading correction refers to applying a gain per pixel to compensate for a dropoff in intensity roughly proportional to a distance from a lens optical center. White balance gain refers to providing digital gains for white balance, offset and clip independently for all color components (e.g., Gr, R, B, Gb in the Bayer pattern).

Components of ISP 206 may convert raw image data into image data in full-color domain, and thus raw processing stage 306 may process image data in the full-color domain in addition to or instead of raw image data.

Resample processing stage 308 performs various operations to convert, resample, or scale image data received from raw processing stage 306. Operations performed by resample processing stage 308 may include a demosaic operation, a per-pixel color correction operation, a Gamma mapping operation, a color space conversion, and a downscaling or sub-band splitting. The demosaic operation refers to converting or interpolating missing color samples from raw image data (e.g., in the Bayer pattern) to output image data into a full-color domain. The demosaic operation may include low pass directional filtering on the interpolated samples to obtain full-color pixels. The per-pixel color correction operation refers to a process of performing color correction on a per-pixel basis using information about relative noise standard deviations of each color channel to correct color without amplifying noise in the image data. The Gamma mapping operation refers to converting image data from input image data values to output data values to perform gamma correction. For the purpose of the Gamma mapping operation, lookup tables (or other structures that index pixel values to another value) for different color components or channels of each pixel (e.g., a separate lookup table for R, G, and B color components) may be used. The color space conversion refers to converting color space of an input image data into a different format. In some embodiments, resample processing stage 308 converts RGB format into YCbCr format for further processing. In some embodiments, resample processing state 308 concerts RBD format into RGB format for further processing.

Central control module 320 may control and coordinate overall operation of other components in ISP 206. Central control module 320 performs operations including monitoring various operating parameters (e.g., logging clock cycles, memory latency, quality of service, and state information), updating or managing control parameters for other components of ISP 206, and interfacing with sensor interface 302 to control the starting and stopping of other components of ISP 206. For example, central control module 320 may update programmable parameters for other components in ISP 206 while the other components are in an idle state. After updating the programmable parameters, central control module 320 may place these components of ISP 206 into a run state to perform one or more operations or tasks. Central control module 320 may also instruct other components of ISP 206 to store image data (e.g., by writing to system memory 230 in FIG. 2) before, during, or after resample processing stage 308. In this way, full-resolution image data in raw or full-color domain format may be stored in addition to or instead of processing the image data output from resample processing stage 308 through backend pipeline stages 340.

Image statistics module 304 performs various operations to collect statistic information associated with the image data. The operations for collecting statistics information may include sensor linearization, replacing patterned defective pixels, sub-sampling raw image data, detection and replacement of non-patterned defective pixels, black level compensation, lens shading correction, and inverse black level compensation. After performing one or more of such operations, statistics information (e.g., 3A statistics (auto-focus, auto white balance (AWB), auto exposure (AE), histograms (e.g., 2D color or component), and any other image data information) may be collected or tracked. In some embodiments, certain pixels' values, or areas of pixel values may be excluded from collections of certain statistics data when preceding operations identify clipped pixels. Although only a single statistics module 304 is illustrated in FIG. 3, multiple image statistics modules may be included in ISP 206. For example, each image sensor 202 may correspond to an individual image statistics module 304. In some embodiments, each statistic module may be programmed by central control module 320 to collect different information for the same or different image data.

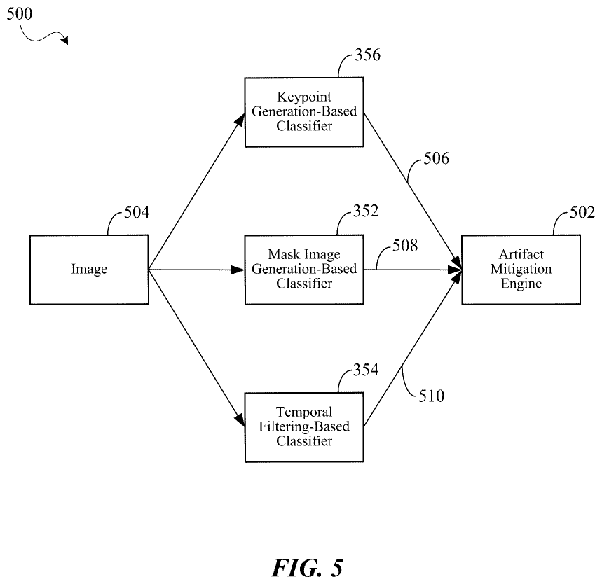

Vision module 322 performs various operations to facilitate computer vision operations at CPU 208, such as facial detection and artifact detection in image data. Vision module 322 may perform various operations including pre-processing, global tone-mapping and Gamma correction, vision noise filtering, resizing, keypoint detection, generation of histogram-of-orientation gradients (HOG), and normalized cross correlation (NCC). The pre-processing may include subsampling or binning operation and computation of luminance if the input image data is not in YCrCb format. Global mapping and Gamma correction can be performed on the pre-processed data on luminance image. Vision noise filtering is performed to remove pixel defects and reduce noise present in the image data, and thereby improve the quality and performance of subsequent computer vision algorithms. Such vision noise filtering may include detecting and fixing dots or defective pixels and performing bilateral filtering to reduce noise by averaging neighboring pixels of similar brightness. Various vision algorithms use images of different sizes and scales. Resizing of an image is performed, for example, by binning or linear interpolation operation. Keypoints are locations within an image that are surrounded by image patches well suited to matching in other images of the same scene or object. Such keypoints are useful in image alignment, computing camera pose, and object tracking. Keypoint detection refers to the process of identifying such keypoints in an image. HOG provides descriptions of image patches for tasks in image analysis and computer vision. HOG can be generated, for example, by (i) computing horizontal and vertical gradients using a difference filter, (ii) computing gradient orientations and magnitudes from the horizontal and vertical gradients, and (iii) binning the gradient orientations. NCC is the process of computing spatial cross-correlation between a patch of image and a kernel. A keypoint generation-based classifier 356 in raw vision module 322 may perform artifact (e.g., green ghost artifacts) detection based on keypoints detected by vision module 322. Details about a structure and operation of keypoint generation-based classifier 356 are provided with reference to FIGS. 5-7, 14, and 15.

Back-end interface 342 receives image data from other image sources than image sensor 102 and forwards the image data to other components of ISP 206 for processing. For example, image data may be received over a network connection and be stored in system memory 230. Back-end interface 342 retrieves the image data stored in system memory 230 and provides the image data to back-end pipeline stages 340 for processing. Back-end interface 342 may convert the retrieved image data to a format that can be utilized by back-end processing stages 340. For instance, back-end interface 342 may convert RGB, YCbCr 4:2:0, or YCbCr 4:2:2 formatted image data into YCbCr 4:4:4 color format.

Back-end pipeline stages 340 processes image data according to a particular full-color format (e.g., YCbCr 4:4:4 or RGB). In some embodiments, components of the back-end pipeline stages 340 may convert image data to a particular full-color format before further processing. Back-end pipeline stages 340 may include noise processing stage 310 and color processing stage 312. Back-end pipeline stages 340 may include other stages not illustrated in FIG. 3.

Noise processing stage 310 performs various operations to reduce noise in the image data. The operations performed by noise processing stage 310 include color space conversion, gamma/de-gamma mapping, temporal filtering, noise filtering, luma sharpening, chroma noise reduction, and artifact detection. The color space conversion may convert an image data from one color space format to another color space format (e.g., RGB format converted to YCbCr format). Gamma/de-gamma operation converts image data from input image data values to output data values to perform gamma correction or reverse gamma correction. Temporal filtering filters noise using a previously-filtered image frame to reduce noise. For example, pixel values of a prior image frame are combined with pixel values of a current image frame. Noise filtering may include, for example, spatial noise filtering. Luma sharpening may sharpen luma values of pixel data while chroma suppression may attenuate chroma to gray (e.g., no color). In some embodiments, the luma sharpening and chroma suppression may be performed simultaneously with spatial nose filtering. The aggressiveness of noise filtering may be determined differently for different regions of an image. Spatial noise filtering may be included as part of a temporal loop implementing temporal filtering. For example, a previous image frame may be processed by a temporal filter and a spatial noise filter before being stored as a reference frame for a next image frame to be processed. In other embodiments, spatial noise filtering may not be included as part of the temporal loop for temporal filtering (e.g., the spatial noise filter may be applied to an image frame after it is stored as a reference image frame and thus the reference frame is not spatially filtered). A temporal filtering-based classifier 354 in noise processing stage 310 may perform artifact (e.g., green ghost artifacts) detection based on a patch distance (e.g., a measure of similarity) between a first patch of pixels of a first image and a second patch of pixels of a second image. Details about a structure and operation of keypoint generation-based classifier 356 are provided with reference to FIGS. 5, 13, and 20.

Color processing stage 312 may perform various operations associated with adjusting color information in the image data. The operations performed in color processing stage 312 include local tone mapping, gain/offset/clip, color correction, three-dimensional color lookup, gamma conversion, color space conversion, and artifact detection. Local tone mapping refers to spatially varying local tone curves in order to provide more control when rendering an image. For instance, a two-dimensional grid of tone curves (which may be programmed by central control module 320) may be bilinearly interpolated such that smoothly varying tone curves are created across an image. In some embodiments, local tone mapping may also apply spatially varying and intensity varying color correction matrices, which may, for example, be used to make skies bluer while turning down blue in the shadows in an image. Digital gain/offset/clip may be provided for each color channel or component of image data. Color correction may apply a color correction transform matrix to image data. 3D color lookup may utilize a three-dimensional array of color component output values (e.g., R, G, B) to perform advanced tone mapping, color space conversions, and other color transforms. Gamma conversion may be performed, for example, by mapping input image data values to output data values in order to perform gamma correction, tone mapping, or histogram matching. Color space conversion may be implemented to convert image data from one color space to another (e.g., RGB to YCbCr). Other processing techniques may also be performed as part of color processing stage 312 to perform other imaging operations, including black and white conversion, sepia tone conversion, negative conversion, or solarize conversion. A mask image generation-based classifier 352 in color processing stage 312 may perform artifact (e.g., green ghost artifacts) detection based on analysis of pixel characteristics of an image. Details about a structure and operation of mask-image-based classifier 352 are provided with reference to FIGS. 5, 8-12, and 16-18.

Output rescale module 314 may resample, transform, and correct distortion on the fly as ISP 206 processes image data. Output rescale module 314 may compute a fractional input coordinate for each pixel and use this fractional coordinate to interpolate an output pixel via a polyphase resampling filter. A fractional input coordinate may be produced from a variety of possible transforms of an output coordinate, such as resizing or cropping an image (e.g., via a simple horizontal and vertical scaling transform), rotating and shearing an image (e.g., via non-separable matrix transforms), perspective warping (e.g., via an additional depth transform) and per-pixel perspective divides applied in piecewise in strips to account for changes in image sensor during image data capture (e.g., due to a rolling shutter), and geometric distortion correction (e.g., via computing a radial distance from the optical center in order to index an interpolated radial gain table, and applying a radial perturbance to a coordinate to account for a radial lens distortion).

Output rescale module 314 may apply transforms to image data as it is processed at output rescale module 314. Output rescale module 314 may include horizontal and vertical scaling components. The vertical portion of the design may implement a series of image data line buffers to hold the “support” needed by the vertical filter. As ISP 206 may be a streaming device, it may be that only the lines of image data in a finite-length sliding window of lines are available for the filter to use. Once a line has been discarded to make room for a new incoming line, the line may be unavailable. Output rescale module 314 may statistically monitor computed input Y coordinates over previous lines and use it to compute an optimal set of lines to hold in the vertical support window. For each subsequent line, output rescale module may automatically generate a guess as to the center of the vertical support window. In some embodiments, the output rescale module 314 may implement a table of piecewise perspective transforms encoded as digital difference analyzer (DDA) steppers to perform a per-pixel perspective transformation between an input image data and output image data in order to correct artifacts and motion caused by sensor motion during the capture of the image frame. Output rescale may provide image data via output interface 316 to various other components of device 100, as discussed above with reference to FIGS. 1 and 2.

In various embodiments, the functionally of components 302 through 350 may be performed in a different order than the order implied by the order of these functional units in the image processing pipeline illustrated in FIG. 3 or may be performed by different functional components than those illustrated in FIG. 3. Moreover, the various components as described in FIG. 3 may be embodied in various combinations of hardware, firmware, or software.

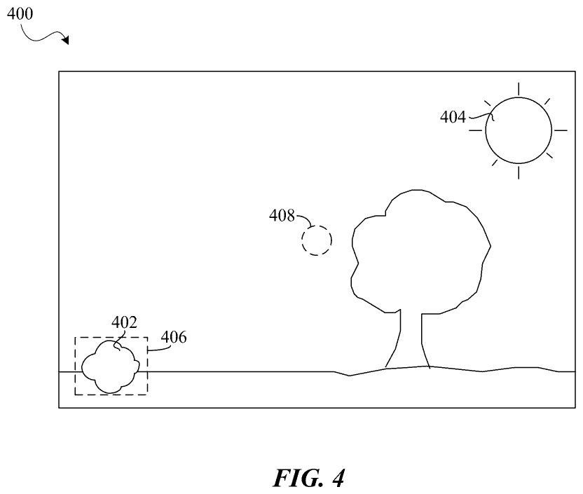

FIG. 4 is an example image 400 including an artifact 402. Artifact 402 is an example a green ghost artifact. A green ghost can occur at a location in an image that is diagonally opposite to a location of a bright region in the image relative to an optical center of a lens in an image sensor capturing the image. Artifact 402 is caused by a bright light source 404 (e.g., the Sun) in image 400 and is located in a region 406 that is diagonal and equidistant from bright light source 404 relative to optical center 408 of the image sensor, according to some embodiments.

Certain techniques for detecting green ghost artifacts rely on analyzing a single characteristic of an image. This can lead to an inaccurate assessment as to whether a green ghost artifact is present in the image. The embodiments described herein utilize multiple classification techniques to determine whether a green ghost artifact is present.

For instance, FIG. 5 is a block diagram of a system 500 for detecting green ghost artifacts, according to some embodiments. As shown in FIG. 5, system 500 includes a keypoint generation-based classifier 356, a mask image generation-based classifier 352, a temporal filtering-based classifier 354, and an artifact mitigation engine 502. Each of keypoint generation-based classifier 356, mask image generation-based classifier 352, temporal filtering-based classifier 354, and/or artifact mitigation engine 502 may be configured to receive an image 504. Image 504 may be obtained via one or more image sensors (e.g., image sensors 202) of an integrated image capture device.

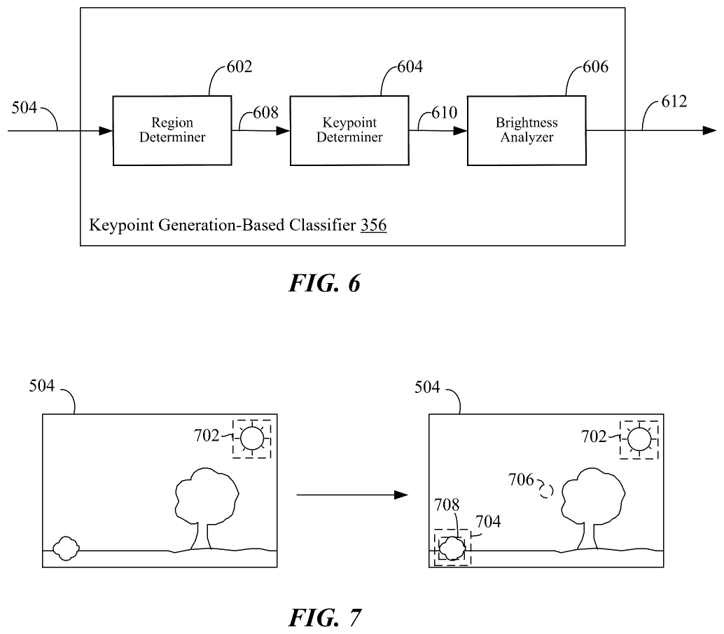

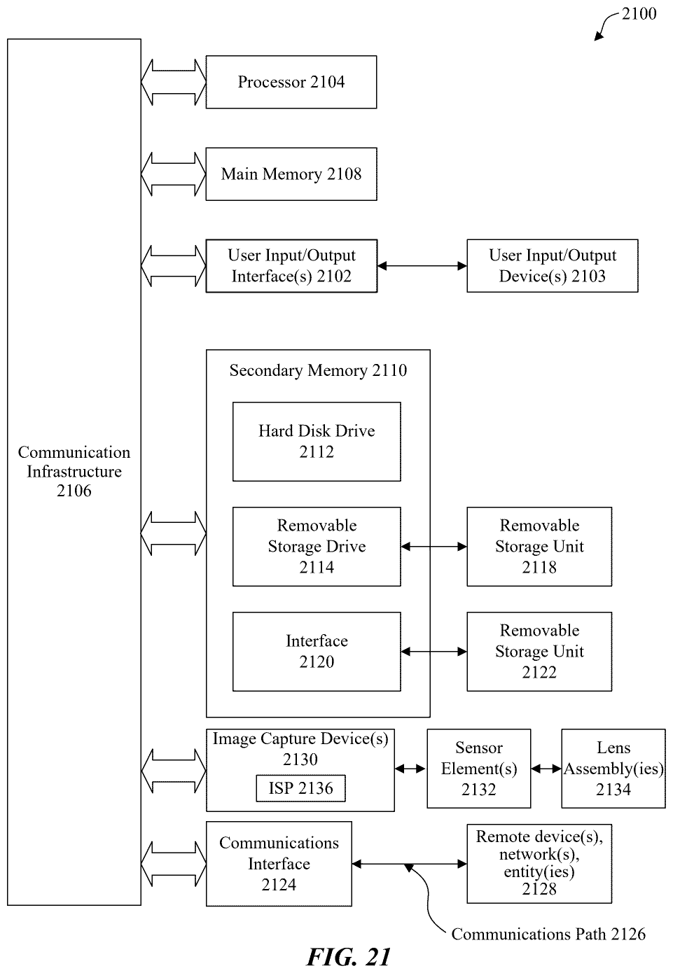

Keypoint generation-based classifier 356 may be implemented by processing logic that can include hardware (e.g., circuitry, dedicated logic, programmable logic, and microcode), software (e.g., instructions executing on a processing device), or a combination thereof. In some embodiments, keypoint generation-based classifier 356 is implemented in one or more software processes executing on one or more processor-based computer systems, such as computer system 2100 as described below with reference to FIG. 21. Keypoint generation-based classifier 356 may be configured to determine a region of interest of image 504 that is likely to include a green ghost artifact and determine keypoints in that region. Keypoint generation-based classifier 356 may filter out keypoints that do not match the size of the light source(s) in image 504. For the remaining keypoints, keypoint generation-based classifier 356 may determine the brightness levels of those keypoints. The brightness levels for pixels corresponding to the keypoints are compared to a threshold. If the threshold is exceeded for a particular pixel, keypoint generation-based classifier 356 sets a probable artifact indicator 506 to a first value for the pixel, where the first value indicates that the pixel likely includes a green ghost artifact. Otherwise, keypoint generation-based classifier 356 sets probable artifact indicator 506 to a second value for the pixel, where the second value indicates that the pixel likely does not include a green ghost artifact. Probable artifact indicator 506 may be provided to artifact mitigation engine 502. Additional details regarding keypoint generation-based classifier 502 are described below with reference to FIGS. 6, 7, 14, and 15.

Mask image generation-based classifier 352 may be implemented by processing logic that can include hardware (e.g., circuitry, dedicated logic, programmable logic, and microcode), software (e.g., instructions executing on a processing device), or a combination thereof. In some embodiments, mask image generation-based classifier 352 is implemented in one or more software processes executing on one or more processor-based computer systems, such as computer system 2100 as described below with reference to FIG. 21. Mask image generation-based classifier 352 may be configured to operate in different image processing modes to detect a green ghost artifact. In a first mode, image 504 may be in a YCbCr color space. In the first mode, one or more pixels of image 504 may be compared to a color mask (e.g., look-up table) that stores different pixel color values and respective, associated confidence values for each of the different colors. Mask image generation-based classifier 352 may match the color of each pixel to a particular color of the color mask. Mask image generation-based classifier 352 may assign the corresponding confidence value (also referred herein as a “chrominance or chroma confidence value”) to the pixel. Pixels having a greenish color are assigned a relatively higher confidence value. In some embodiments, confidence values may range between 0.0 and 1.0, where higher the confidence value, the greener the pixel. Mask image generation-based classifier 352 may also determine the luminance value of each of the pixels, where higher the luminance value, the more likely the pixel is a green ghost. For a given pixel, mask image generation-based classifier 352 may combine the determined chrominance value and the luminance value to determine a final confidence value. Mask image generation-based classifier 352 may generate and output a mask image 508 including the final confidence values for all the pixels.

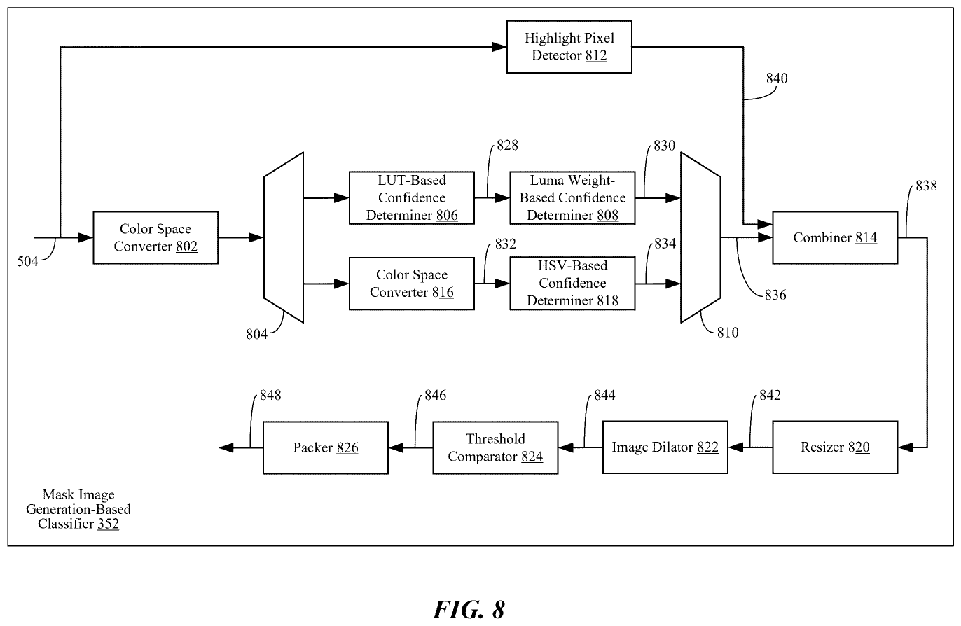

In a second mode, mask image generation-based classifier 352 may convert the pixel values of image 504 to a (hue, saturation, value (or brightness); collectively referred to as “HSV”) color space. Mask image generation-based classifier 352 may determine the HSV values for each pixel, determine whether each of the HSV values meets (e.g., reaches or exceeds) a respective threshold value, and generate a hue confidence value, a saturation confidence value, and a brightness confidence value for each pixel accordingly. Mask image generation-based classifier 352 may combine such confidence values to generate a final confidence value for a given pixel and output mask image 508 including the final confidence values for all the pixels. Additional details regarding mask image generation-based classifier 352 are described below with reference to FIGS. 8-12 and 16-19.

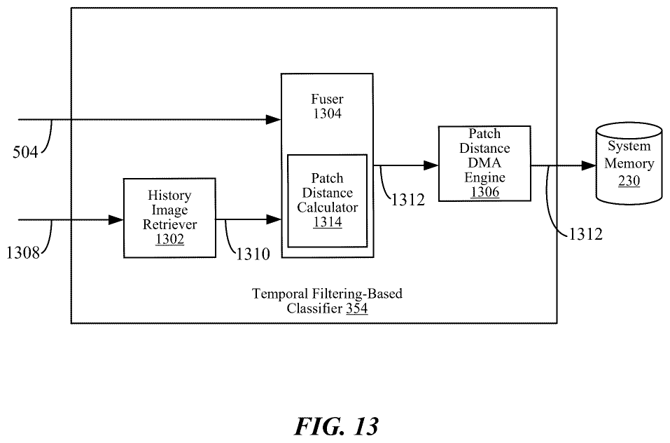

Temporal filtering-based classifier 354 may be implemented by processing logic that can include hardware (e.g., circuitry, dedicated logic, programmable logic, and microcode), software (e.g., instructions executing on a processing device), or a combination thereof. In some embodiments, temporal filtering-based classifier 354 is implemented in one or more software processes executing on one or more processor-based computer systems, such as computer system 2100 as described below with reference to FIG. 21. Temporal filtering-based classifier 354 may be configured to determine a patch distance 510 (e.g., a measure of similarity) between a first patch of pixels of image 504 and corresponding pixels in a second patch of pixels of a history image corresponding to image 504. The determined patch distance 510 corresponds to a confidence level indicative of whether the patch(es) include a green ghost. Additional details regarding temporal filtering-based classifier 354 are described below with reference to FIGS. 13 and 20.

Artifact mitigation engine 502 may be implemented by processing logic that can include hardware (e.g., circuitry, dedicated logic, programmable logic, and microcode), software (e.g., instructions executing on a processing device), or a combination thereof. In some embodiments, artifact mitigation engine 502 is implemented in one or more software processes executing on one or more processor-based computer systems, such as computer system 2100 as described below with reference to FIG. 21. Artifact mitigation engine 502 may be configured to receive probable artifact indicators 506 output by keypoint generation-based classifier 356, mask image 508 output by mask image generation-based classifier 352, and patch distance 510 output by temporal filtering-based classifier 354. Artifact mitigation engine 502 may be configured to mitigate a green ghost artifact in image 504 based on probable artifact indicators 506, mask image 508, and/or patch distance 510. For instance, artifact mitigation engine 502 may be configured to combine probable artifact indicators 506, mask image 508, and/or patch distance 510 and compare the combined value to a predetermined threshold. If the combined value meets (e.g., reaches or exceeds) the predetermined threshold, then artifact mitigation engine 502 may determine that the likelihood that a green ghost artifact is present in image 504 is relatively high and mitigate the green ghost artifact. In some embodiments, one or more of probable artifact indicators 506, mask image 508, and/or patch distance 510 may be weighted to indicate a level of contribution for determining how likely a green ghost artifact is present in image 504. In some embodiments, artifact mitigation engine 502 may mitigate the green ghost artifact by generating replacement pixels (e.g., pixels that replace pixels including a green ghost artifact) using a neural network (NN) or other machine learning (ML)-based technique that has been trained to mitigate the presence of green ghost artifacts.

FIG. 6 is a block diagram of a keypoint generation-based classifier 356, according to some embodiments. As shown in FIG. 6, keypoint generation-based classifier 356 may include a region determiner 602, a keypoint determiner 604, and a brightness analyzer 606. Each of region determiner 602, keypoint determiner 604, and brightness analyzer 606 may be implemented by processing logic that can include hardware (e.g., circuitry, dedicated logic, programmable logic, and microcode), software (e.g., instructions executing on a processing device), or a combination thereof. In some embodiments, region determiner 602, keypoint determiner 604, and brightness analyzer 606 are implemented in one or more software processes executing on one or more processor-based computer systems, such as computer system 2100 as described below with reference to FIG. 21.

Region determiner 602 may be configured to receive image 504 and determine a region of image 504 that is likely to include a green ghost artifact. For instance, region determiner 602 may determine a first region of image 504 in which a bright light source is included. Region determiner 602 may analyze one or more characteristics for each pixel of image 504 and determine whether such characteristics meet (e.g., reach or exceed) a predetermined threshold. The characteristics may include pixel brightness values, estimated scene depth, camera zoom level, camera focus level, pixel color values, and/or the like. Region determiner 602 may determine that a block of contiguous pixels of image 504 having characteristics that meet the predetermined threshold corresponds to a bright light source in image 504. The determined block is identified as the first region of image 504 in which a bright light source is included. In some embodiments, region determiner 602 may expand the identified first region of image 504 by a range of pixels in at least one of the x direction or y direction to increase the size of the first region. For instance, FIG. 7 is image 504 in which a first region 702 is identified.

Based on the identified first region 702, region determiner 602 may identify a second region of image 504 that is likely to include a green ghost artifact. For instance, region determiner 602 may determine a second region of image 504 that is diagonally opposite to the first region relative to the optical center of the image sensor that captured image 504. The second region may be approximately the same size as the first region. For example, as shown in FIG. 6, region determiner 602 may determine a second region 704 that is diagonally opposite to first region 702 relative to an optical center 706 of the image sensor that captured image 504. Region determiner 602 may provide an indication 608 of first region 702 and/or second region 704 to keypoint determiner 604. Indication 608 may specify the location of the pixels corresponding to first region 702 and/or second region 704, the characteristics of the pixels corresponding to first region 702 and/or second region 704, the size (e.g., in pixels) of the determined light source in first region 702 of image 504.

Keypoint determiner 604 may be configured to determine keypoints in the determined second region 704 of image 504. Keypoints may refer to distinctive or salient points in image 504 that can be used to identify, describe, or match objects or features in the scene. For instance, keypoints may include points that are well-localizable in the face of image noise. If the same image is seen with a different amount of noise, the location of a keypoint should not change. Keypoints may also be defined in terms of repeatability. If an image of the same scene is taken from the same viewpoint at different points in time, possibly with different illumination characteristics, the same keypoint should be recognizable across all such images. Other useful characteristics of keypoints can be defined in terms of geometric invariance (e.g., the ability to recognize the projection of the same surface point in different images taken from different viewpoints) or distinctiveness (e.g., the unique characteristics of the local image appearance in the neighborhood of a keypoint). Keypoint determiner 604 may be configured to detect such keypoints within second region 704 of image 504. In example shown in FIG. 7, keypoint determiner 604 may identify keypoint 708, which corresponds to a green ghost artifact. Keypoint determiner 604 may utilize various techniques for detecting keypoints including Scale Invariant Feature Transform (SIFT)-based keypoint detection techniques, Speeded Up Robust Features (SURF)-based keypoint detection techniques, Accelerated KAZE (AKAZE) based keypoint detection techniques, Learned Invariant Feature Transform (LIFT)-based based keypoint detection techniques, and/or the like.

Keypoints may appear at different scales of image 504. For instance, keypoint determiner 604 may be configured to generate an image pyramid including multiple octaves and multiple scales per octave based on image 504. Images in different octaves have different resolutions, and images in the same octave (but in a different scale) have the same resolution, but with different amounts of blurring. After generating the image pyramid, keypoint determiner 604 may generate a response map (RM) image for each of the images of the pyramid. Each pixel of the RM image includes a response value. To determine the response values of a particular RM image, keypoint determiner 604 may apply filters (e.g., Laplacian filters) to the corresponding image of image pyramid. Keypoint determiner 604 then determines the response values of the RM image using the Laplacian filtered results. Keypoint determiner 604 may determine keypoint candidates for second region 704 of image 504 based on a comparison of the RM images of the same octave. In some embodiments, keypoint determiner 604 compares each pixel of an RM image that satisfies a threshold value to its neighboring pixels of the same scale and to neighboring pixels in the adjacent scale of the same octave. If a given pixel is either larger than all its neighbors or smaller than all its neighbors, the pixel is identified as a keypoint candidate. Keypoint determiner 604 may then determine keypoints from the keypoint candidates based on an analysis of RM images in different octaves. For instance, for each keypoint candidate, keypoint determiner 604 may perform non-maxima suppression (NMS) using a pixel plane (e.g., a 3×3 pixel plane) in the adjacent octave. The keypoint candidate may be validated as a keypoint if the pixel value of the keypoint candidate is larger or smaller than neighboring pixels of the pixel plane in the adjacent octave. Otherwise, the keypoint candidate is discarded.

After detecting the keypoints in the second region of image 504, keypoint determiner 604 may filter the keypoints based on the size of the light source detected in image 504. For instance, the size of the green ghost artifacts corresponds to the size of the light source in the image. Thus, keypoint determiner 604 may remove keypoints that do not correspond to the size of the light source to limit the green ghost detection analysis performed by keypoint generation-based classifier 356. Keypoint determiner 604 may provide an indication 610 of the determined keypoints to brightness analyzer 606. Indication 610 may indicate the scale in which the keypoint was determined, the size of the keypoint, the brightness level of the pixels of the keypoint, and/or the location of the pixels corresponding to the keypoint.

Brightness analyzer 606 may be configured to compare the brightness level of a given keypoint to a predetermined brightness threshold. If the brightness level meets the predetermined brightness threshold, then brightness analyzer 606 may determine that the keypoint likely corresponds to a green ghost artifact. If the brightness level does not meet the predetermined brightness threshold, then brightness analyzer 606 determines that the keypoint does not likely correspond to a green ghost artifact. In some embodiments, the predetermined brightness threshold is configurable to control the aggressiveness of green ghost detection. Upon determining that a particular keypoint corresponds to a green ghost artifact, brightness analyzer 606 may generate a probable artifact indicator 612. Probable artifact indicator 612 is an example of probable artifact indicator 506, as described above with reference to FIG. 5. In some embodiments, probable artifact indicator 612 indicates that the pixel values of the keypoint meet the brightness threshold and likely corresponds to a green ghost artifact. In some embodiments, brightness analyzer 606 may store probable artifact indicator 612 in a header of the keypoint (e.g., as a 1-bit value). Brightness analyzer 606 may also store additional information in the header, including the scale at which the keypoint was detected. Brightness analyzer 606 may provide probable artifact indicator 612 to artifact mitigation engine 502 (e.g., by providing the header of the keypoint to artifact mitigation engine 502).

FIG. 8 is a block diagram of mask image generation-based classifier 352, according to some embodiments. Mask image generation-based classifier 352 may be configured to operate in different image processing modes for determining whether a green ghost artifact is present in image 504. For example, in a first mode, mask image generation-based classifier 352 may be configured to detect a green ghost artifact based on a color mask that stores confidence values for different color values. In a second mode, mask image generation-based classifier 352 may be configured to detect a green ghost artifact based on a parametric model. As shown in FIG. 8, mask image generation-based classifier 352 may include a color space converter 802, a first selector 804, a look-up table (LUT)-based confidence determiner 806, a luma weight-based confidence determiner 808, a second selector 810, a highlight pixel detector 812, a combiner 814, a color space converter 816, an HSV-based confidence determiner 818, a resizer 820, an image dilator 822, a threshold comparator 824, and a packer 826. Each of color space converter 802, first selector 804, look-up table (LUT)-based confidence determiner 806, luma weight-based confidence determiner 808, second selector 810, highlight pixel detector 812, combiner 814, color space converter 816, HSV-based confidence determiner 818, resizer 820, image dilator 822, threshold comparator 824, and packer 826 may be implemented by processing logic that can include hardware (e.g., circuitry, dedicated logic, programmable logic and microcode), software (e.g., instructions executing on a processing device), or a combination thereof. In some embodiments, color space converter 802, first selector 804, look-up table (LUT)-based confidence determiner 806, luma weight-based confidence determiner 808, second selector 810, highlight pixel detector 812, combiner 814, color space converter 816, HSV-based confidence determiner 818, resizer 820, image dilator 822, threshold comparator 824, and packer 826 are implemented in one or more software processes executing on one or more processor-based computer systems, such as computer system 2100 as described below with reference to FIG. 21.

Color space converter 802 may be configured to receive image 504 that is in a first color space (e.g., a YCbCr space). Color space converter 802 may be configured to convert image 504 to a different color space depending on the mode in which mask image generation-based classifier 352. For instance, in the first image processing mode of mask image generation-based classifier 352, color space converter 802 may not convert the color space of image 504. In the second image processing mode of mask image generation-based classifier 352, color space converter 802 may convert image 504 to an RGB (red, green, blue) color space. The mode of mask image generation-based classifier 352 may be determined based on a value stored in a configuration register. For instance, a value of ‘0’ stored in the configuration register may correspond to the first mode, and a value of ‘1’ stored in the configuration register may correspond to the second mode.

In the first mode, first selector 804 may be configured to provide unconverted image 504 to LUT-based confidence determiner 806. LUT-based confidence determiner 806 may be configured to compare pixel color value(s) of image 504 to pixel color value(s) stored in a color mask (e.g., a LUT). Each of the pixel color value(s) of the LUT may be associated with a respective confidence (or chrominance) value. Pixel color value(s) that are associated with green ghost artifacts (e.g., shades of green) are assigned relatively higher confidence value(s), while other pixel color value(s) are assigned relatively lower confidence value(s). For each pixel value of a pixel of image 504 that matches a pixel value of the color mask, LUT-based confidence determiner 806 may assign the corresponding confidence value associated with the matched pixel value to the pixel of image 504. In some embodiments, a luma-dependent scale factor may be applied to the determined chrominance values determined for pixel(s) of image 504. The scale factor may be determined based on a data structure (e.g., a LUT) that stores different scale factors that are associated with different luma values. The luma values may represent the brightness of the achromatic (e.g., black and white) portion of image 504 and may be obtained via analyzing metadata associated with image 504. To determine a scale factor for a particular pixel of image 504, LUT-based confidence determiner 806 may determine the luma value for the pixel and determine a corresponding scale factor utilizing the data structure. LUT-based confidence determiner 806 may provide an indication 828 of which pixel(s) of image 504 were assigned a chrominance confidence value, along with their respective chrominance confidence value(s). Pixels in image 504 whose values that fall in between the color mask and/or luma LUT entries are interpolated bilinearly of the corresponding entry values according to the value difference to the neighbor mask or LUT entries.

Luma weight-based confidence determiner 808 may be configured to determine another confidence value (e.g., a luma confidence value) for each pixel of image 504 that was assigned a chrominance confidence value (as identified by indication 828). To determine the luma confidence value for a particular pixel of image 504, luma weight-based confidence determiner 818 may determine and compare the luma value of the pixel to one or more predetermined threshold values. For instance, if the luma value is less than a first predetermined threshold, the luma confidence value is assigned a first value. If the luma value is greater than or equal to the first predetermined threshold and less than or equal to a second predetermined threshold, then the luma confidence value is assigned a second value. If the luma value is greater than the second predetermined threshold, then the luma confidence value is assigned a third value.

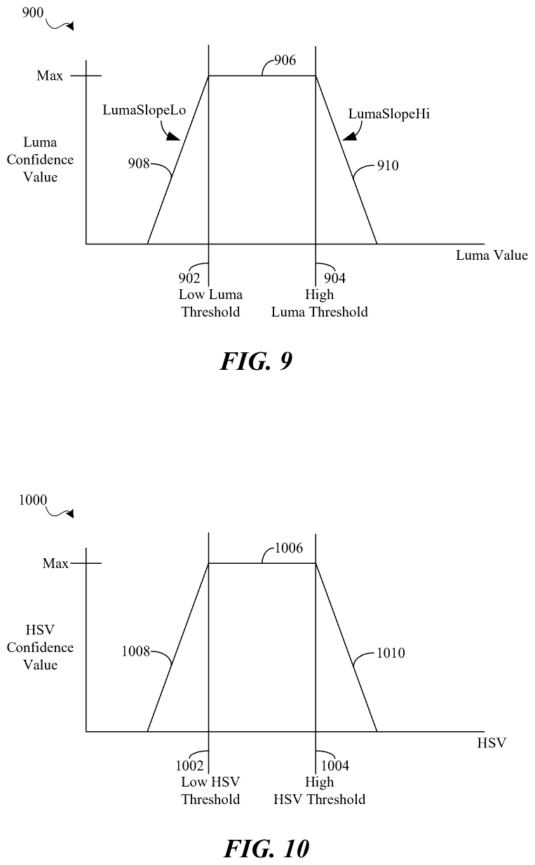

For example, FIG. 9 is a graph 900 illustrating different luma confidence values, according to some embodiments. As shown in FIG. 9, the x-axis of graph 900 corresponds to luma values and the y-axis corresponds to luma confidence values. As also shown in FIG. 9, two thresholds are specified: a low luma threshold 902 and a high luma threshold 904. A distribution including a first portion 906, a second portion 908, and a third portion 910 illustrates how the value of the luma confidence value is determined depending on the relationship between the luma value and low and high luma thresholds 902 and 904. For instance, the luma confidence value may be determined based on Equations 1-3, which are provided below:

$$If Y < Low Luma Threshold : \qquad ( Equation 1 )$$

$$luma confidence value = max - min ( ( low luma threshold - Y ) * LumaSlopeLo ) , max )$$

$$If Y \geq low luma threshold \& Y \leq hi luma threshold : \qquad ( Equation 2 )$$

$$luma confidence value = max$$

$$If Y > hi luma threshold : \qquad ( Equation 3 )$$

$$luma confidence value = max - min ( ( Y - hi luma threshold ) * LumaSlopeHi ) , max )$$

where Y represents the luma value of a pixel, and max represents the maximum luma confidence value.

Based on Equation 1, if the luma value Y of a pixel is less than low luma threshold 902, then the luma confidence value is determined by subtracting the luma value Y from the value of low luma threshold 902. The resulting difference may then be multiplied by the slope of second portion 908 (LumaSlopeLo). The resulting product may compared to the maximum luma confidence value (max) to determine the minimum value between the two values. The determined minimum value may be subtracted from the maximum luma confidence value. The resulting difference corresponds to the luma confidence value determined for the pixel. In some embodiments, the maximum luma confidence value is 64. However, it is noted that the maximum luma confidence value may be set to other values.

Based on Equation 2, if the luma value Y of a pixel is greater than or equal to low luma threshold 902 and less than or equal to high luma threshold 904, the luma confidence value may be set to the maximum luma confidence value. Based on Equation 3, if the luma value Y of a pixel is greater than high luma threshold 904, then the luma confidence value is determined by subtracting the value of the high luma threshold 904 from the luma value of the pixel. The resulting difference may then be multiplied by the slope of third portion 910 (LumaSlopeHi). The resulting product may compared to the maximum luma confidence value to determine the minimum value between the two values. The determined minimum value may be subtracted from the maximum luma confidence value. The resulting difference corresponds to the luma confidence value determined for the pixel.

For each pixel of image 504 for which a chrominance value and a luma weight-based confidence value are determined, luma weight-based confidence determiner 808 may be configured to combine (e.g., multiply) the chrominance value and the luma confidence value to determine an overall (or final) confidence value 830 for the pixel. In the first mode, confidence value(s) 830 determined for pixel(s) of image 504 are provided to second selector 810.

In the second mode, first selector 804 may be configured to provide image 504 that has been converted to the second color space to color space converter 816. The second color space may be a RGB (red, green, blue) color space, where the pixel values of image 504 are converted to RGB values. Color space converter 816 may be configured to convert the RGB values to HSV values 832, which are provided to HSV-based confidence determiner 818.

For each pixel of pixel(s) of image 504, HSV-based confidence determiner 818 may be configured to determine a first (or hue) confidence value based on the hue value of the pixel, a second (or saturation) confidence value based on the saturation value of the pixel, and a third (or brightness) confidence value based on the brightness value of the pixel. Hue, saturation and brightness values can be computed in either RGB or YCbCr color space.

To determine the hue confidence value for a particular pixel of image 504, HSV-based confidence determiner 818 may compare the hue value to one or more predetermined threshold values. For instance, if the hue value is less than a first predetermined threshold, the hue confidence value is assigned a first value. If the hue value is greater than or equal to the first predetermined threshold and less than or equal to a second predetermined threshold, then the hue confidence value is assigned a second value. If the hue value is greater than the second predetermined threshold, then the hue confidence value is assigned a third value. The saturation confidence values and the brightness confidence values may be determined in a similar manner. In some embodiments, the first predetermined thresholds used to determine each of the hue confidence values, the saturation confidence values, and the brightness confidence values may be the same predetermined thresholds. In other embodiments, one or more of the first predetermined thresholds may be different predetermined thresholds. Similarly, in some embodiments, the second predetermined thresholds used to determine each of the hue confidence values, the saturation confidence values, and the brightness confidence values may be the same predetermined thresholds. In other embodiments, one or more of the second predetermined thresholds may be different predetermined thresholds.

For example, FIG. 10 is a graph 1000 illustrating different hue (H), saturation(S), or brightness (V)-based confidence values, according to some embodiments. As shown in FIG. 10, the same distribution is utilized to determine each of the hue, saturation, and brightness confidence values. However, it is noted that different distributions may be used for determining one or more of the hue, saturation, and brightness confidence values. The x-axis of graph 1000 corresponds to hue, saturation, or brightness values for a given pixel and the y-axis corresponds to hue, saturation, or brightness confidence values. As also shown in FIG. 10, two thresholds are specified: a low threshold 1002 and a high threshold 1004. A distribution including a first portion 1006, a second portion 1008, and a third portion 1010 illustrates how the value of the hue, saturation, or brightness confidence values are determined depending on the relationship between the hue, saturation, or brightness values and low and high thresholds 1002 and 1004. The hue, saturation, or brightness confidence values may be determined in a similar manner as described above with reference to luma confidence value. For instance, the hue, saturation, or brightness confidence values may be determined based on the slope of second portion 1008 when the hue, saturation, or brightness values are less than low threshold 1002. The hue, saturation, or brightness confidence values may be based on the maximum hue, saturation, or brightness confidence values when the hue, saturation, or brightness values are greater than or equal to low threshold 1002 and less than or equal to high threshold 1004. The hue, saturation, or brightness confidence values may be based on the slope of third portion 1010 when the hue, saturation, or brightness values are greater than high threshold 1004.

For each pixel, HSV-based confidence determiner 818 may be configured to generate a final confidence value 834 by combining (e.g., multiplying) the hue, saturation, and brightness confidence values determined for the pixel. In the second mode, confidence value(s) 834 determined for pixel(s) of image 504 are provided to second selector 810. In some embodiments, more than one parametric model may be utilized to determine a respective final confidence level for a given pixel. In some embodiments, the confidence values generated from each parametric model may be analyzed to determine the final confidence value for a given pixel. For example, a final confidence level determined by a first parametric model may be added to a final confidence level determined by a second parametric model. The resulting value may be assigned to the pixel as the final confidence value. In another example, a final confidence level determined by the second parametric model may be subtracted from a final confidence level determined by the first parametric model. The resulting value may be assigned to the pixel as the final confidence value. In a further example, the maximum (or minimum) of a final confidence level determined by the first parametric model and a final confidence level determined by the first parametric model may be assigned to a given pixel as the final confidence value.

Second selector 810 may be configured to select the output from luma weight-based confidence determiner 808 (e.g., final confidence value(s) 830) or the output of HSV-based confidence determiner 808 (e.g., final confidence value(s) 834) depending on the image processing mode of mask image generation-based classifier 352. For instance, in the first mode, second selector 810 may select final confidence value(s) 830 and provide final confidence value(s) 830 to combiner 814. In the second mode, second selector 810 may select final confidence value(s) 834 and provide final confidence value(s) 834 to combiner 814. The selected final confidence value(s) are shown as selected confidence value(s) 836.

Highlight pixel detector 812 may be configured to identify highlight pixels in image 504 and determine confidence values for such pixels. Highlight pixels may correspond to pixels having a relatively high brightness, which results in various features of the pixel (e.g., color, contour, texture) to be imperceptible. To identify highlight pixels, an elliptical weight function may be utilized for a given pixel of image 504, where an elliptical shape is defined relative to a center point defined by a Cb (or C1) coordinate and a Cr (or C2) coordinate for the elliptical shape. If the Cb and Cr pixel values for a pixel fall within the elliptical shape, then highlight pixel detector 812 determines that the pixel is a highlight pixel. Highlight pixel detector 812 may also determine a distance of the Cb and Cr pixel values from the center point (referred herein as “CDist”). Once a highlight pixel is identified, a chrominance confidence value and a luma confidence value may be determined for the highlight pixel.

To determine the chrominance confidence value for a particular highlight pixel of image 504, highlight pixel determiner 812 may compare the CDist value to a predetermined threshold. If the CDist value is less than or equal to predetermined threshold, the chrominance confidence value is assigned a first value. If the CDist value is greater than the predetermined threshold, then the chrominance confidence value is assigned a second value.

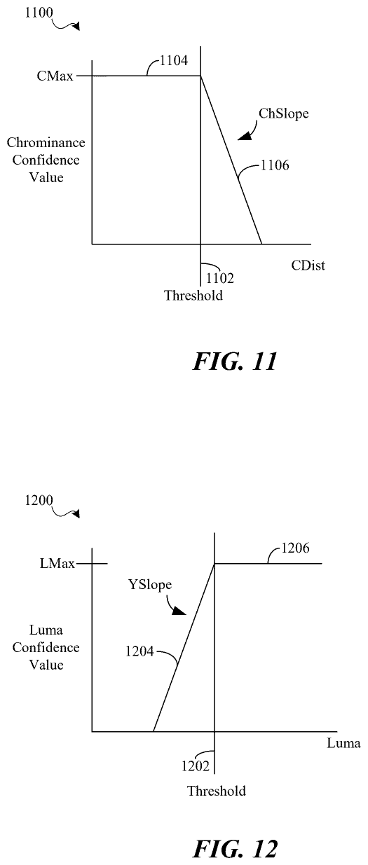

For example, FIG. 11 is a graph 1100 illustrating different chrominance confidence values, according to some embodiments. As shown in FIG. 11, the x-axis of graph 1100 corresponds to CDist values and the y-axis corresponds to chrominance confidence values. As also shown in FIG. 11, a distribution including a first portion 1104 and a second portion 1106 illustrates how the value of the chrominance confidence value is determined depending on the relationship between the CDist value and a threshold 1102. For instance, the chrominance confidence value may be determined based on Equations 4-5, which are provided below:

$$If CDist \leq Threshold : \qquad ( Equation 4 )$$

$$luma confidence value = c max$$

$$If CDist > t hreshold : \qquad ( Equation 5 )$$

$$chrominance confidence value = c max - min ( ( CDist - Threshold ) * ChSlope ) , c max )$$

where cmax represents the maximum chrominance confidence value.

Based on Equation 4, if the CDist value is less than or equal to threshold 1102, then the chrominance confidence value is set to the maximum chrominance confidence value (cmax). However, if the CDist value is greater than threshold 1102, then based on Equation 5, the chrominance confidence value is determined by subtracting the value of threshold 1102 from the CDist value. The resulting difference may then be multiplied by the slope of second portion 1106 (ChSlope). The resulting product may compared to the maximum chrominance confidence value to determine the minimum value between the two values. The determined minimum value may be subtracted from the maximum chrominance confidence value. The resulting difference corresponds to the chrominance confidence value determined for the highlight pixel. In some embodiments, the maximum chrominance confidence value is 64. However, it is noted that the maximum chrominance confidence value may be set to other values.

To determine the luma confidence value for a particular highlight pixel of image 504, highlight pixel determiner 812 may compare the luma value of the highlight pixel to a predetermined threshold. If the luma value is less than the predetermined threshold, the luma confidence value is assigned a first value. If the luma value is greater than or equal to the predetermined threshold, then the luma confidence value is assigned a second value.

For example, FIG. 12 is a graph 1200 illustrating different luma confidence values, according to some embodiments. As shown in FIG. 12, the x-axis of graph 1200 corresponds to luma values and the y-axis corresponds to luma confidence values. As also shown in FIG. 12, a distribution including a first portion 1204 and a second portion 1206 illustrates how the value of the luma confidence value is determined depending on the relationship between the luma value and a threshold 1202. For instance, the luma confidence value may be determined based on Equations 6-7, which are provided below:

$$If Y < Threshold : \qquad ( Equation 6 )$$

$$luma confidence value = l max - min ( ( Threshold - Y ) * YSlope ) , l max )$$

$$If Y \geq Threshold : \qquad ( Equation 7 )$$

$$luma confidence value = l max$$

where lmax represents the maximum luma confidence value.

Based on Equation 6, if the luma value is less than threshold 1202, then the luma confidence value is determined by subtracting the luma value from threshold 1202. The resulting difference may then be multiplied by the slope of first portion 1204 (YSlope). The resulting product may compared to the maximum luma confidence value (lmax) to determine the minimum value between the two values. The determined minimum value may be subtracted from the maximum luma confidence value. The resulting difference corresponds to the luma confidence value determined for the highlight pixel. In some embodiments, the maximum luma confidence value is 64. However, it is noted that the maximum luma confidence value may be set to other values.

For each highlight pixel, highlight pixel determiner 812 may be configured to combine (e.g., multiply) the determined chrominance confidence value and the luma confidence value to generate a combined highlight confidence value 840.

For each pixel of pixel(s) of image 504, combiner 814 may be configured to analyze selected confidence value 836 with highlight confidence value 840 to generate a final confidence value for that pixel. In one example, combiner 814 may add selected confidence value 836 with highlight confidence value 840 to generate the final confidence value. In another example, combiner 814 may subtract highlight confidence value 840 from selected confidence value 836 to generate the final confidence value. In a further example, combiner 814 may determine the maximum (or minimum) value between the selected confidence value 836 and highlight confidence value 840 and set the final confidence value to the maximum (or minimum) value.

After determining the final confidence value(s) for pixel(s) of image 504, combiner 814 may generate a mask (or confidence) image 838 that includes the final confidence value(s) determined for the pixel(s) of image 504. In some embodiments, mask image 830 may be a grayscale mask image including the final confidence value(s), where higher confidence value(s) represent a higher confidence of the detected colors (e.g., green), and where lower confidence value(s) represent a lower confidence of the detected colors.

Resizer 820 may be configured to downscale (e.g., reduce the resolution) of mask image 838 to generate a downscaled mask image 842. In some embodiments, mask image 838 may be a single channel image and the bit width of each pixel value is 8 bits. Accordingly, the output of resizer may an 8-bit image. The downscaling may be performed to reduce the memory required to store downscaled mask image 842.

Image dilator 822 may be configured to perform image dilation on downscaled mask image 842. For instance, for each patch of pixel(s) (e.g., a 3×3 patch) of downscaled mask image 842, image dilator 822 may analyze the pixels in the patch (e.g., 3×3 neighboring pixels) and determine the maximum final confidence value in the patch. Image dilator 822 may assign the maximum final confidence value to each pixel in the patch. The dilated mask image (shown as dilated mask image 844) is provided to threshold comparator 824

Threshold comparator 824 may be configured to generate a binary output mask image 846 based on dilated mask image 842. For instance, threshold comparator 824 may compare each of the confidence values stored in dilated mask image 842 to a predetermined threshold. If a particular confidence value of a pixel of dilated mask image 842 meets (e.g., reaches or exceeds) the predetermined threshold, the final confidence value for that pixel may be set to a value of “1.” Otherwise, the final confidence value for that pixel may be set to a value of “0.” That is, threshold comparator 824 converts the confidence values to binary values. A value of “1” may be mapped to a value of “255”, and a value of “0” may be mapped to value of 0.

Packer 826 may be configured to operate when mask image generation-based classifier 352 is in a packed bits mode. When in this mode, rather than mapping “0” and “1” values to 0 and 255, respectively, packer 826 may pack every 8 binary values in the same row into one 8-bit number. Zero values may be padded at the end if the width of downscaled mask image 840 is not a multiple of 8. The resulting packed mask image (packed mask image 848) may be provided to artifact mitigation engine 502. When not operating in the packed bits mode, binary output mask image 846 may be provided to artifact mitigation engine 502. Accordingly, binary output mask image 846 or packed mask image 848 examples of mask image 508, as described above with reference to FIG. 5, depending on whether or not mask image generation-based classifier is operating in packed bits mode.

FIG. 13 is a block diagram of temporal filtering-based classifier 354, according to some embodiments. Temporal filtering attempts to improve an image frame by combining it with a motion-compensated history frame. Successful fusion of these two frames depends on whether motion compensation was successful or not. This can be achieved by calculating the patch distance for every pixel pair. Green ghost pixels are not properly motion compensated. Therefore, patch distance is likely to be large for green ghost pixels. This process in temporal filtering can be utilized for green ghost detection. As shown in FIG. 13, temporal filtering-based classifier 354 may include a history image retriever 1302, a fuser 1304, a patch distance calculator 1314, and a patch distance direct memory access (DMA) engine 1306. Each of history image retriever 1302, fuser 1304, patch distance calculator 1314, and patch distance DMA engine 1306 may be implemented by processing logic that can include hardware (e.g., circuitry, dedicated logic, programmable logic, and microcode), software (e.g., instructions executing on a processing device), or a combination thereof. In some embodiments, history image retriever 1302, patch distance calculator 1314, and patch distance DMA engine 1306 are implemented in one or more software processes executing on one or more processor-based computer systems, such as computer system 2100 as described below with reference to FIG. 21.

History image retriever 1302 may be configured to obtain a prior (or “history”) image 1308 (e.g., from system memory 230) and image 504. Prior image 1008 may be an image that was captured by the image sensor prior to capturing image 504 (e.g., prior image 1308 was captured earlier in time than image 504). History image retriever 1302 may perform a warping operation (e.g., a linear or non-linear transformation) on prior image 1308 to spatially-align prior image 1308 with image 504 (e.g., to apply motion compensation to prior image 1308). The resulting image is referred herein as a “warped image” (shown as warped image 1310).

Fuser 1304 may be configured to fuse (e.g., combine) warped image 1310 with image 504 to generate a fused image. Fuser 1304 may optionally perform noise reduction on the fused image (e.g., using multi-band noise reduction (MNBR)-based techniques). As part of the fusion process, patch distance calculator 1314 may be configured to determine a patch distance 1312 between patches of warped image 1310 and patches of image 504. Patch distance 1312 is a measure of similarity between two pixels that takes into account not only the pixel value itself, but the neighboring pixels as well. A patch includes a pixel (e.g., a central pixel) and other pixels within a defined spatial distance from the central pixel. Patch distance calculator 1314 may determine patch distance 1312 between two patches as a sum of Euclidian distances between corresponding pixels in both patches. A relatively large patch distance for a particular patch may indicate that a green ghost artifact is located in the particular patch. For 5×5 patches, patch distance calculator 1314 may determine patch distance 1312 based on Equation 8, which is provided below:

$$Patch Distance = {\sum }_{i = - 2}^{2} {\sum }_{j = - 2}^{2} {ED}^{2} ( P {1}_{ij} , P {2}_{ij} ) \qquad ( Equation 8 )$$

where ED (P1ᵢⱼ, P2ᵢⱼ) is a Euclidian distance between pixels P1ᵢⱼ. P2ᵢⱼ of the first patch and second patch, respectively, and i and j are indexes within a 5×5 patch window. It is noted that the patch size can be other sizes (e.g., 3×3, 1×1 (in a single pixel mode), etc.). Patch distance 1312 is sent to patch distance DMA engine 1306.

Patch distance DMA engine 1306 may be configured to store patch distance 1312 in a memory, such as system memory 230. The direct memory access nature of patch distance DMA engine 1306 may enable patch distance DMA engine 1306 to write patch distance 1312 directly to system memory 230 without the involvement of a CPU (e.g., processor 2104, as shown in FIG. 21). Patch distance DMA engine 1306 may store patch distance 1312 in system memory 230 in one of different formats. For instance, patch distance DMA engine 1306 may store patch distance 1312 in either a native bits per pixel (bpp) (e.g., 16 bpp) format or in a packed 1-bit format. For example, when operating in the packed bits mode, patch distance DMA engine 1306 may compare patch distance 1312 to a predetermined threshold. If the value of patch distance 1312 meets (e.g., reaches or exceeds) the predetermined threshold, then patch distance DMA engine 1306 may store patch distance 1312 in system memory 230 as a value of “1.” Otherwise, patch distance DMA engine 1306 may store patch distance 1312 in system memory 230 as a value of “0.” When not operating in the packed bits mode, patch distance DMA engine 1306 may store patch distance 1312 in the native bpp format. Artifact mitigation engine 502 may be configured to retrieve patch distance 1312 from system memory 230 when performing green ghost mitigation. Patch distance 1312 is an example of patch distance 510, as described above with reference to FIG. 5.

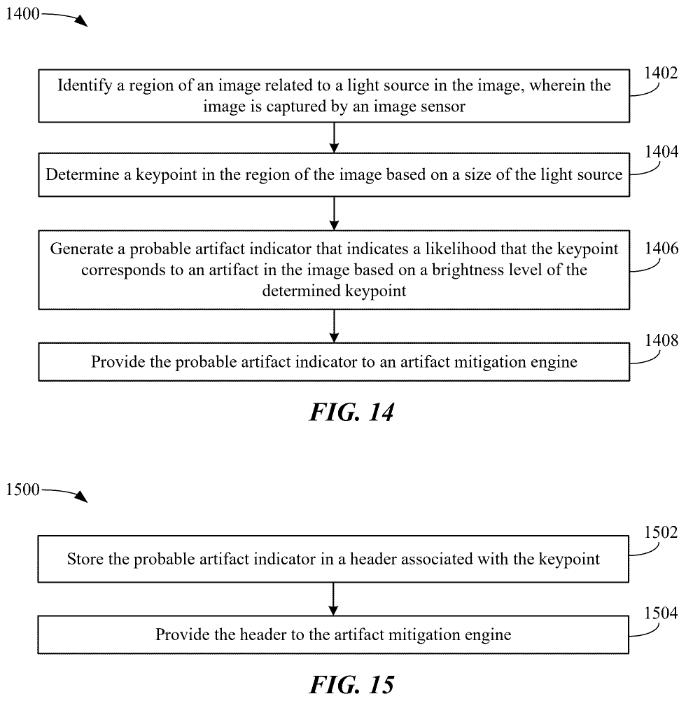

FIG. 14 is a flowchart of a method 1400 for identifying a green ghost artifact utilizing a keypoint generation-based classifier, according to some embodiments. Method 1400 can be performed by processing logic that can include hardware (e.g., circuitry, dedicated logic, programmable logic, and microcode), software (e.g., instructions executing on a processing device), or a combination thereof. It is to be appreciated that not all operations may be needed to perform the disclosure provided herein. Further, some of the operations may be performed simultaneously, or in a different order than shown in FIG. 14, as will be understood by a person of ordinary skill in the art.

Method 1400 shall be described with reference to FIGS. 5-7. Method 1400 is not limited to that embodiment.

In 1402, region determiner 602 of keypoint generation-based classifier 356 may identify region 704 of image 504 related to a light source in image 504, where image 504 is captured by an image sensor (e.g., image sensors 202 or sensor element(s) 2132, as respectively shown in FIGS. 3 and 21).

In 1404, keypoint determiner 604 of keypoint generation-based classifier 356 may determine keypoint 708 in region 704 of image 504 based on a size of the light source.

In 1406, brightness analyzer 606 of keypoint generation-based classifier 356 may generate a probable artifact indicator (e.g., probable artifact indicator 506 or 612) that indicates a likelihood that keypoint 708 corresponds to an artifact in image 504 based on a brightness level of the determined keypoint 708.

In 1408, brightness analyzer 606 may provide the probable artifact indicator (e.g., probable artifact indicator 506 or 612) to artifact mitigation engine 502. Artifact mitigation engine 502 may be configured to mitigate a green ghost artifact in image 504 based at least on probable artifact indicator 506. For instance, artifact mitigation engine 502 may be configured to compare probable artifact indicator 506 to a predetermined threshold. If probable artifact indicator 506 meets (e.g., reaches or exceeds) the predetermined threshold, then artifact mitigation engine 502 may determine that the likelihood that a green ghost artifact is present in image 504 is relatively high and mitigate the green ghost artifact.

FIG. 15 is a flowchart of a method 1500 for providing a probable artifact indicator, according to some embodiments. Method 1500 can be performed by processing logic that can include hardware (e.g., circuitry, dedicated logic, programmable logic, and microcode), software (e.g., instructions executing on a processing device), or a combination thereof. It is to be appreciated that not all operations may be needed to perform the disclosure provided herein. Further, some of the operations may be performed simultaneously, or in a different order than shown in FIG. 15, as will be understood by a person of ordinary skill in the art.

Method 1500 shall be described with reference to FIGS. 5-7. Method 1500 is not limited to that embodiment.

In 1502, brightness analyzer 606 may store probable artifact indicator 612 in a header associated keypoint 708. Probable artifact indicator 612 may generated in accordance with the operations described above in FIG. 14.

In 1504, brightness analyzer 606 may provide the header to artifact mitigation engine 502. Artifact mitigation engine 502 may be configured to read the header and obtain probable artifact indicator 612 from the header. Artifact mitigation engine 502 may determine the likelihood that a green ghost artifact is present in image 504 based at least on the obtained probable artifact indicator 612 and mitigate the green ghost artifact if the likelihood is relatively high.

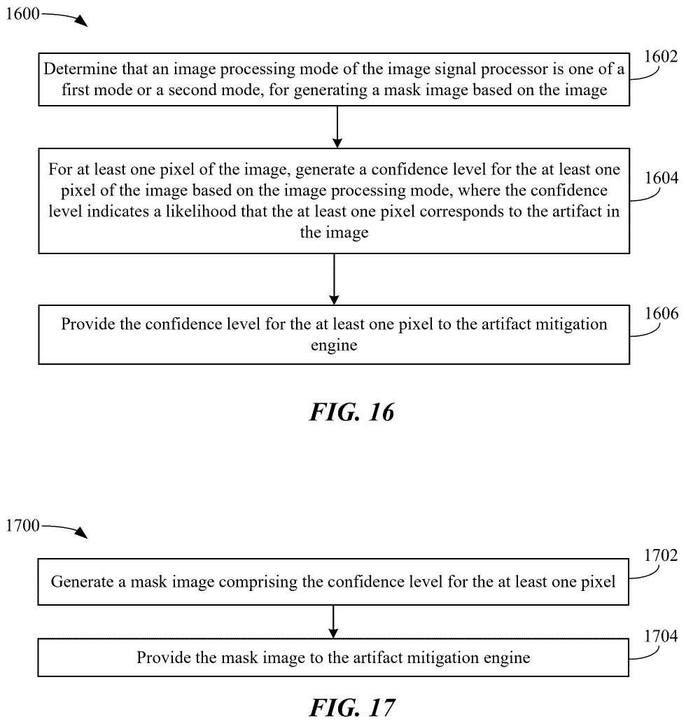

FIG. 16 is a flowchart of a method 1600 for identifying a green ghost artifact utilizing a mask image generation-based classifier, according to some embodiments. Method 1600 can be performed by processing logic that can include hardware (e.g., circuitry, dedicated logic, programmable logic, and microcode), software (e.g., instructions executing on a processing device), or a combination thereof. It is to be appreciated that not all operations may be needed to perform the disclosure provided herein. Further, some of the operations may be performed simultaneously, or in a different order than shown in FIG. 16, as will be understood by a person of ordinary skill in the art.

Method 1600 shall be described with reference to FIG. 5. Method 1600 is not limited to that embodiment.

In 1602, mask image generation-based classifier 352 may determine that an image processing mode of an image signal processor (e.g., image signal processor 206 or image signal processor 2136, as respectively shown in FIGS. 2 and 21) is one of a first mode or a second mode, for generating a mask image based on image 504. For instance, mask image generation-based classifier 352 may read a configuration register that stores a value indicative of the image processing mode to determine which image processing mode the image signal processor operates.

In 1604, for at least one pixel of image 504, mask image generation-based classifier 352 may generate a confidence level for the at least one pixel of image 504 based on the image processing mode, where the confidence level indicates a likelihood that the at least one pixel corresponds to the artifact in image 504. In the first mode, the confidence level is based on a color value and a luma value of the at least one pixel. In the second mode, the confidence level is based on a hue value of the at least one pixel, a saturation value of the at least one pixel, and a brightness value of the at least one pixel.

In 1606, mask image generation-based classifier 352 may provide the confidence level for the at least one pixel to artifact mitigation engine 502 (e.g., as mask image 508). Artifact mitigation engine 502 may be configured to mitigate a green ghost artifact in image 504 based at least on mask image 508. For instance, artifact mitigation engine 502 may be configured to compare the confidence level to a predetermined threshold. If the confidence level meets (e.g., reaches or exceeds) the predetermined threshold, then artifact mitigation engine 502 may determine that the likelihood that a green ghost artifact is present in image 504 is relatively high and mitigate the green ghost artifact.

FIG. 17 is a flowchart of a method 1700 for providing the confidence level to the artifact mitigation engine, according to some embodiments. Method 1700 can be performed by processing logic that can include hardware (e.g., circuitry, dedicated logic, programmable logic, and microcode), software (e.g., instructions executing on a processing device), or a combination thereof. It is to be appreciated that not all operations may be needed to perform the disclosure provided herein. Further, some of the operations may be performed simultaneously, or in a different order than shown in FIG. 17, as will be understood by a person of ordinary skill in the art.

Method 1700 shall be described with reference to FIGS. 5 and 8. Method 1700 is not limited to that embodiment.

In 1702, mask image generation-based classifier 352 may generate mask image 508 including the confidence level for the at least one pixel. For instance, threshold comparator 824 may generate binary output mask image 846 including the confidence level for the at least one pixel. When mask image generation-based classifier 352 operates in a packed bits mode, packer 826 may generate packed mask image 848 based on binary output mask image 846.

In 1704, mask image generation-based classifier 352 may provide mask image 508 to artifact mitigation engine 502. For instance, when mask image generation-based classifier 352 does not operate in the packed bits mode, threshold comparator 824 may provide binary output mask image 846 to artifact mitigation engine 502. When mask image generation-based classifier 352 operates in the packed bits mode, packer 826 may provide packed mask image 848 to artifact mitigation engine 502. Artifact mitigation engine 502 may be configured to mitigate a green ghost artifact in image 504 based at least on mask image 508. For instance, artifact mitigation engine 502 may be configured to obtain a confidence level from mask image 508 and compare the confidence level to a predetermined threshold. If the confidence level meets (e.g., reaches or exceeds) the predetermined threshold, then artifact mitigation engine 502 may determine that the likelihood that a green ghost artifact is present in image 504 is relatively high and mitigate the green ghost artifact.

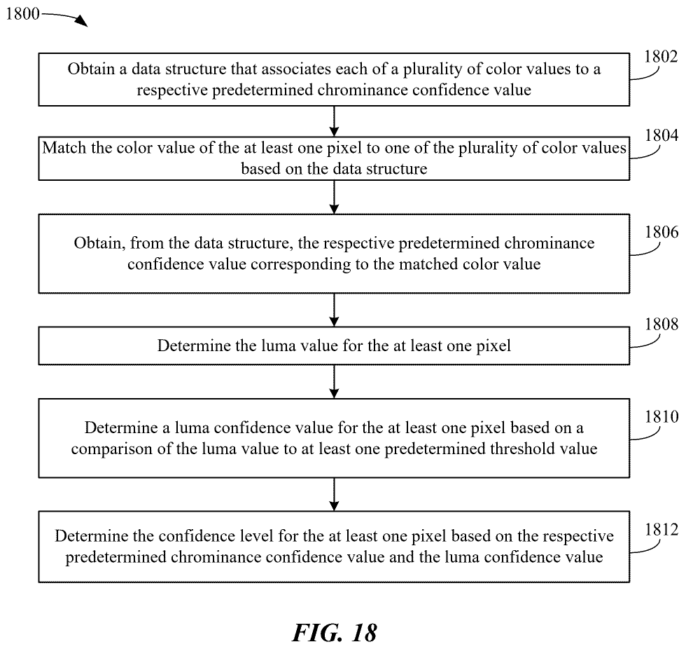

FIG. 18 is a flowchart of a method 1800 for determining the confidence level utilizing mask image generation-based classifier 352 based on a first image processing mode, according to some embodiments. Method 1800 can be performed by processing logic that can include hardware (e.g., circuitry, dedicated logic, programmable logic, and microcode), software (e.g., instructions executing on a processing device), or a combination thereof. It is to be appreciated that not all operations may be needed to perform the disclosure provided herein. Further, some of the operations may be performed simultaneously, or in a different order than shown in FIG. 18, as will be understood by a person of ordinary skill in the art.

Method 1800 shall be described with reference to FIGS. 8-9. Method 1800 is not limited to that embodiment.

In 1802, LUT-based confidence determiner 806 of mask image generation-based classifier 352 may obtain a data structure (e.g., a LUT) that associates each color value to a respective predetermined chrominance confidence value.

In 1804, LUT-based confidence determiner 806 may match the color value of the at least one pixel to one of the color values based on the data structure. In some embodiments, when the color value of the at least one pixel falls between the two color values of the plurality of color values, the determined color value may be an interpolation of the two color values.

In 1806, LUT-based confidence determiner 806 may obtain, from the data structure, the respective predetermined chrominance confidence value corresponding to the matched color value. LUT-based confidence determiner 806 may provide the respective predetermined chrominance confidence value to luma weight-based confidence determiner 808 via indication 828.

In 1808, luma weight-based confidence determiner 808 of mask image generation-based classifier 352 may determine the luma value for the at least one pixel.

In 1810, luma weight-based confidence determiner 808 may determine a luma confidence value for the at least one pixel based on a comparison of the luma value to at least one predetermined threshold value (e.g., low luma threshold 902 and/or high luma threshold 904).

In 1812, luma weight-based confidence determiner 808 may determine the confidence level (e.g., confidence level 830) for the at least one pixel based on the respective predetermined chrominance confidence value and the luma confidence value. For instance, luma weight-based confidence determiner 808 may multiply respective predetermined chrominance confidence value and the luma confidence value to determine confidence level 830. Confidence level 830 may be provided to artifact mitigation engine 502 (e.g., via mask image 508). Artifact mitigation engine 502 may be configured to mitigate a green ghost artifact in image 504 based at least on confidence level 830. For instance, artifact mitigation engine 502 may be configured to obtain confidence level 830 from mask image 508 and compare confidence level 830 to a predetermined threshold. If confidence level 830 meets (e.g., reaches or exceeds) the predetermined threshold, then artifact mitigation engine 502 may determine that the likelihood that a green ghost artifact is present in image 504 is relatively high and mitigate the green ghost artifact.

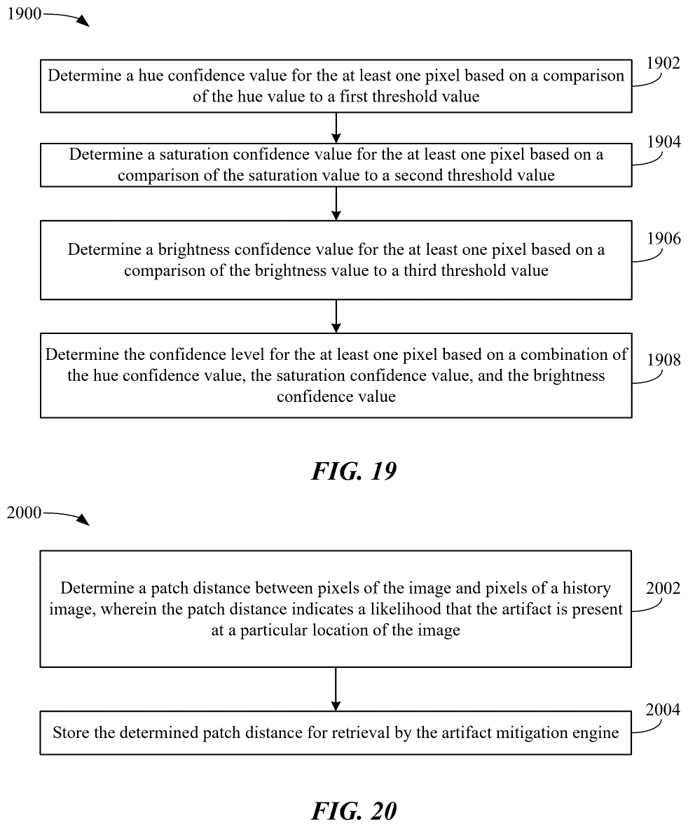

FIG. 19 is a flowchart of a method 1900 for determining the confidence level utilizing mask image generation-based classifier 352 based on a second image processing mode, according to some embodiments. Method 1900 can be performed by processing logic that can include hardware (e.g., circuitry, dedicated logic, programmable logic, and microcode), software (e.g., instructions executing on a processing device), or a combination thereof. It is to be appreciated that not all operations may be needed to perform the disclosure provided herein. Further, some of the operations may be performed simultaneously, or in a different order than shown in FIG. 19, as will be understood by a person of ordinary skill in the art.

Method 1900 shall be described with reference to FIGS. 8 and 10. Method 1900 is not limited to that embodiment.

In 1902, HSV-based confidence determiner 818 of mask image generation-based classifier 352 may determine a hue confidence value for the at least one pixel based on a comparison of the hue value to a first threshold value (e.g., low HSV threshold and/or high HSV threshold 1004).

In 1904, HSV-based confidence determiner 818 may determine a saturation confidence value for the at least one pixel based on a comparison of the saturation value to a second threshold value (e.g., low HSV threshold and/or high HSV threshold 1004).

In 1906, HSV-based confidence determiner 818 may determine a brightness confidence value for the at least one pixel based on a comparison of the brightness value to a third threshold value (e.g., low HSV threshold and/or high HSV threshold 1004).

In 1908, mask image generation-based classifier 352 may determine the confidence level for the at least one pixel based on the hue confidence value, the saturation confidence value, and the brightness confidence value. For instance, HSV-based confidence determiner 818 combine (e.g., multiply) the hue confidence value, the saturation confidence value, and the brightness confidence value to generate final confidence value 834. As described above with reference to FIG. 8, a mask image (e.g., binary output mask image 846 or packed mask image 848) that stores final confidence values 834 may be generated and provided artifact mitigation engine 502. Artifact mitigation engine 502 may be configured to mitigate a green ghost artifact in image 504 based at least on final confidence values 834. For instance, artifact mitigation engine 502 may be configured to obtain confidence levels 834 from a mask image (e.g., binary output mask image 846 or packed mask image 848) and compare the confidence levels 834 to a predetermined threshold. If confidence level 834 meet (e.g., reach or exceed) the predetermined threshold, then artifact mitigation engine 502 may determine that the likelihood that a green ghost artifact is present in image 504 is relatively high and mitigate the green ghost artifact.

FIG. 20 is a flowchart of a method 2000 for determining a patch distance utilizing temporal filtering-based classifier 354 based, according to some embodiments. Method 2000 can be performed by processing logic that can include hardware (e.g., circuitry, dedicated logic, programmable logic, and microcode), software (e.g., instructions executing on a processing device), or a combination thereof. It is to be appreciated that not all operations may be needed to perform the disclosure provided herein. Further, some of the operations may be performed simultaneously, or in a different order than shown in FIG. 20, as will be understood by a person of ordinary skill in the art.

Method 2000 shall be described with reference to FIGS. 5 and 13. Method 2000 is not limited to that embodiment.

In 2002, patch distance calculator 1314 of temporal filtering-based classifier 354 may determine patch distance 1312 between pixels of image 504 and pixels of history image 1308 (or warped image 1310), wherein patch distance 1312 indicates a likelihood that the artifact is present at a particular location of image 1312.

In 2004, patch distance DMA engine 1306 may store patch distance 1312 for retrieval by artifact mitigation engine 502. Patch distance DMA engine 1306 may store patch distance 1312 in system memory 230. In some embodiments, patch distance DMA engine 1306 may store the determined patch distance 1312 in one of a bpp format (e.g., a native 16 bpp format) or a 1-bit packed format. For example, when not operating in a packed bits mode, patch distance DMA engine 1306 may store patch distance 1312 in the bpp format. When operating in the packed bits mode, patch distance DMA engine 1306 may store patch distance 1312 in the 1-bit packed format. Artifact mitigation engine 502 may be configured to obtain patch distance 1312 from system memory 230. Artifact mitigation engine 502 may determine the likelihood that a green ghost artifact is present in image 504 based at least on the obtained patch distance 1312 and mitigate the green ghost artifact if the likelihood is relatively high.

Various aspects can be implemented, for example, using one or more computer systems, such as computer system 2100 shown in FIG. 21. Computer system 2100 can be any computer capable of performing the functions described herein, such as the functions of device 100 of FIGS. 1 and 2, image signal processor 206 of FIG. 3, keypoint generation-based classifier 356, mask image generation-based classifier 352, and temporal filtering-based classifier 354 (and the components thereof), as respectively described in FIGS. 5, 6, 8, and 13, and the operations of FIGS. 14-20. Computer system 2100 includes one or more processors (also called central processing units, or CPUs), such as a processor 2104. Processor 2104 is connected to a communication infrastructure 2106 (e.g., a bus). Computer system 2100 also includes user input/output device(s) 2103, such as monitors, keyboards, and pointing devices, that communicate with communication infrastructure 2106 through user input/output interface(s) 2102. Computer system 2100 also includes a main or primary memory 2108, such as random access memory (RAM). Main memory 2108 may include one or more levels of cache. Main memory 2108 has stored therein control logic (e.g., computer software) and/or data.

Computer system 2100 may also include one or more secondary storage devices or memory 2110. Secondary memory 2110 may include, for example, a hard disk drive 2112 and/or a removable storage device or drive 2114. Removable storage drive 2114 may be a floppy disk drive, a magnetic tape drive, a compact disk drive, an optical storage device, tape backup device, and/or any other storage device/drive.

Removable storage drive 2114 may interact with a removable storage unit 2118. Removable storage unit 2118 includes a computer usable or readable storage device having stored thereon computer software (control logic) and/or data. Removable storage unit 2118 may be a floppy disk, magnetic tape, compact disk, DVD, optical storage disk, and/or any other computer data storage device. Removable storage drive 2114 reads from and/or writes to removable storage unit 2118 in a well-known manner.

According to some aspects, secondary memory 2110 may include other means, instrumentalities or other approaches for allowing computer programs and/or other instructions and/or data to be accessed by computer system 2100. Such means, instrumentalities or other approaches may include, for example, a removable storage unit 2122 and an interface 2120. Examples of the removable storage unit 2122 and the interface 2120 may include a program cartridge and cartridge interface (e.g., such as that found in video game devices), a removable memory chip (e.g., an EPROM or PROM) and associated socket, a memory stick and USB port, a memory card and associated memory card slot, and/or any other removable storage unit and associated interface.

Computer system 2100 may further include a communication or network interface 2124. Communication interface 2124 enables computer system 2100 to communicate and interact with any combination of remote devices, remote networks, remote entities, etc. (individually and collectively referenced by reference number 2128). For example, communication interface 2124 may allow computer system 2100 to communicate with remote devices 2128 over communications path 2126, which may be wired and/or wireless, and which may include any combination of LANs, WANs, the Internet, etc. Control logic and/or data may be transmitted to and from computer system 2100 via communication path 2126.

Image capture device(s) 2130 may include one or more camera units configured to capture images, e.g., images which may be processed to generate enhanced versions of the captured images, e.g., based on this disclosure. Image capture device(s) 2130 may include one or more lens assemblies 2134, where each lens assembly has a separate focal length. For example, one lens assembly may have a shorter focal length relative to the focal length of another lens assembly. Each of lens assembly(ies) 2134 may have a separate associated sensor element (e.g., sensor element(s) 2132). Alternatively, lens assembly(ies) 2134 may share common sensor element(s) 2132. Sensor element(s) 2132 may include image sensor(s) configured to convert light waves into electrical signals representing an image. Image capture device(s) 2130 may capture still and/or video images. Output from image capture device(s) 2130 may be processed, at least in part, by processor 2104 and/or a dedicated image processing unit or image signal processor 2136 incorporated within image capture device(s) 2130. Image signal processor 2136 may be configured to process captured images based on any suitable image processing algorithm. For example, image signal processor 2136 can process raw data that represents the captured images into a suitable file format, such as Y′UV, YUV, YCbCr, YPbPr, or any other file format. As another example, image signal processor 2136 may perform automatic white balance (AWB) and may resize images as needed. As an option, image signal processor 2136 may be configured to compress the images into a suitable format by employing any available compression standard, such as JPEG or MPEG and their associated variants. One or more of keypoint generation-based classifier 356, mask image generation-based classifier 352, and/or temporal filtering-based classifier 354 may be implemented via image signal processor 2136 and/or processor 2104. Captured images may be stored in main memory 2108 and/or secondary memory 2110.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 2100, main memory 2108, secondary memory 2110 and removable storage units 2118 and 2122, as well as tangible articles of manufacture embodying any combination of the foregoing. Such control logic, when executed by one or more data processing devices (e.g., computer system 2100), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 21. In particular, aspects may operate with software, hardware, and/or operating system implementations other than those described herein.

It is to be appreciated that the Detailed Description section, and not the Abstract of the Disclosure section, is intended to be used to interpret the claims. The Abstract of the Disclosure section may set forth one or more but not all possible aspects of the present disclosure as contemplated by the inventor(s), and thus, are not intended to limit the subjoined claims in any way.

Unless stated otherwise, the specific aspects are not intended to limit the scope of claims that are drafted based on this disclosure to the disclosed forms, even where only a single example is described with respect to a particular feature. The disclosed aspects are thus intended to be illustrative rather than restrictive, absent any statements to the contrary. The application is intended to cover such alternatives, modifications, and equivalents that would be apparent to a person skilled in the art having the benefit of this disclosure.

The foregoing disclosure outlines features of several aspects so that those skilled in the art may better understand the aspects of the present disclosure. Those skilled in the art will appreciate that they may readily use the present disclosure as a basis for designing or modifying other processes and structures for carrying out the same purposes and/or achieving the same advantages of the aspects introduced herein. Those skilled in the art will also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
identifying a region of an image related to a light source in the image, wherein the image is captured by an image sensor;
determining a keypoint in the region of the image based on a size of the light source;
generating a probable artifact indicator that indicates a likelihood that the keypoint corresponds to an artifact in the image based on a brightness level of the determined keypoint; and
providing the probable artifact indicator to an artifact mitigation engine.

2. The method of claim 1, wherein providing the probable artifact indicator comprises:
storing the probable artifact indicator in a header associated with the keypoint; and
providing the header to the artifact mitigation engine.

3. The method of claim 1, further comprising:
determining that an image processing mode of an image signal processor is one of a first mode or a second mode, for generating a mask image based on the image;
for at least one pixel of the image, generating a confidence level for the at least one pixel of the image based on the image processing mode, wherein the confidence level indicates a likelihood that the at least one pixel corresponds to the artifact in the image,
wherein in the first mode, the confidence level is based on a color value and a luma value of the at least one pixel, and
wherein in the second mode, the confidence level is based on a hue value of the at least one pixel, a saturation value of the at least one pixel, and a brightness value of the at least one pixel; and
providing the confidence level for the at least one pixel to the artifact mitigation engine.

4. The method of claim 3, wherein providing the confidence level comprises:
generating a mask image comprising the confidence level for the at least one pixel; and
providing the mask image to the artifact mitigation engine.

5. The method of claim 3, wherein the image processing mode is the first mode, and wherein generating the confidence level in the image processing mode comprises:
obtaining a data structure that associates each of a plurality of color values to a respective predetermined chrominance confidence value;
matching the color value of the at least one pixel to one of the plurality of color values based on the data structure;
obtaining the respective predetermined chrominance confidence value corresponding to the matched color value;
determining the luma value for the at least one pixel;
determining a luma confidence value for the at least one pixel based on a comparison of the luma value to at least one predetermined threshold value; and
determining the confidence level for the at least one pixel based on the respective predetermined chrominance confidence value and the luma confidence value.

6. The method of claim 3, wherein the image processing mode is the second mode, and wherein generating the confidence level in the second mode comprises:
determining a hue confidence value for the at least one pixel based on a comparison of the hue value to a first threshold value;
determining a saturation confidence value for the at least one pixel based on a comparison of the saturation value to a second threshold value;
determining a brightness confidence value for the at least one pixel based on a comparison of the brightness value to a third threshold value; and
determining the confidence level for the at least one pixel based on the hue confidence value, the saturation confidence value, and the brightness confidence value.

7. The method of claim 1, further comprising:
determining a patch distance between pixels of the image and pixels of a history image, wherein the patch distance indicates a likelihood that the artifact is present at a particular location of the image; and
storing the determined patch distance for retrieval by the artifact mitigation engine.

8. The method of claim 7, wherein storing the determined patch distance comprises storing the determined patch distance in one of a bits per pixel format or a 1-bit packed format.

9. A system, comprising:
a memory; and
at least one processor configured to:
identify a region of an image related to a light source in the image, wherein the image is captured by an image sensor;
determine a keypoint in the region of the image based on a size of the light source;
generate a probable artifact indicator that indicates a likelihood that the keypoint corresponds to an artifact in the image based on a brightness level of the determined keypoint; and
provide the probable artifact indicator to an artifact mitigation engine.

10. The system of claim 9, wherein, to provide the probable artifact indicator, the at least one processor is configured to:
store the probable artifact indicator in a header associated with the keypoint; and
provide the header to the artifact mitigation engine.

11. The system of claim 9, wherein the at least one processor is further configured to:
determine that an image processing mode of an image signal processor is one of a first mode or a second mode, for generating a mask image based on the image;
for at least one pixel of the image, generate a confidence level for the at least one pixel of the image based on the image processing mode, wherein the confidence level indicates a likelihood that the at least one pixel corresponds to the artifact in the image,
wherein in the first mode, the confidence level is based on a color value and a luma value of the at least one pixel, and
wherein in the second mode, the confidence level is based on a hue value of the at least one pixel, a saturation value of the at least one pixel, and a brightness value of the at least one pixel; and
provide the confidence level for the at least one pixel to the artifact mitigation engine.

12. The system of claim 11, wherein, to provide, the confidence level, the at least one processor is configured to:
generate a mask image comprising the confidence level for the at least one pixel; and
provide the mask image to the artifact mitigation engine.

13. The system of claim 11, wherein the image processing mode is the first mode, and wherein, to generate the confidence level in the first mode, the at least one processor is configured to:
obtain a data structure that associates each of a plurality of color values to a respective predetermined chrominance confidence value;
match the color value of the at least one pixel to one of the plurality of color values based on the data structure;
obtain the respective predetermined chrominance confidence value corresponding to the matched color value;
determine the luma value for the at least one pixel;
determine a luma confidence value for the at least one pixel based on a comparison of the luma value to at least one predetermined threshold value; and
determine the confidence level for the at least one pixel based on the respective predetermined chrominance confidence value and the luma confidence value.

14. The system of claim 11, wherein the image processing mode is the second mode, and wherein, to generate the confidence level in the second mode, the at least one processor is configured to:
determine a hue confidence value for the at least one pixel based on a comparison of the hue value to a first threshold value;
determine a saturation confidence value for the at least one pixel based on a comparison of the saturation value to a second threshold value;
determine a brightness confidence value for the at least one pixel based on a comparison of the brightness value to a third threshold value; and
determine the confidence level for the at least one pixel based on the hue confidence value, the saturation confidence value, and the brightness confidence value.

15. The system of claim 9, wherein the at least one processor is further configured to:
determine a patch distance between pixels of the image and pixels of a history image, wherein the patch distance indicates a likelihood that the artifact is present at a particular location of the image; and
store the determined patch distance for retrieval by the artifact mitigation engine.

16. The system of claim 15, wherein, to store the determined patch distance, the at least one processor is configured to:
store the determined patch distance in one of a bits per pixel format or a 1-bit packed format.

17. A non-transitory computer readable medium having instructions stored thereon that, when executed by at least one processor, cause the at least one processor to perform operations comprising:
identifying a region of an image related to a light source in the image, wherein the image is captured by an image sensor;
determining a keypoint in the region of the image based on a size of the light source;
generating a probable artifact indicator that indicates a likelihood that the keypoint corresponds to an artifact in the image based on a brightness level of the determined keypoint; and
providing the probable artifact indicator to an artifact mitigation engine.

18. The non-transitory computer readable medium of claim 17, wherein providing the probable artifact indicator comprises:
storing the probable artifact indicator in a header associated with the keypoint; and
providing the header to the artifact mitigation engine.

19. The non-transitory computer readable medium of claim 17, the operations further comprising:
determining that an image processing mode of an image signal processor is one of a first mode or a second mode, for generating a mask image based on the image;
for at least one pixel of the image, generating a confidence level for the at least one pixel of the image based on the image processing mode, wherein the confidence level indicates a likelihood that the at least one pixel corresponds to the artifact in the image,
wherein in the first mode, the confidence level is based on a color value and a luma value of the at least one pixel, and
wherein in the second mode, the confidence level is based on a hue value of the at least one pixel, a saturation value of the at least one pixel, and a brightness value of the at least one pixel; and
providing the confidence level for the at least one pixel to the artifact mitigation engine.

20. The non-transitory computer readable medium of claim 19, wherein providing the confidence level comprises:
generating a mask image comprising the confidence level for the at least one pixel; and
providing the mask image to the artifact mitigation engine.
